(19) United States
(12) Patent Application Publication
(10) Pub. No.: US 2014/0163703 A1
(43) Pub. Date: Jun. 12, 2014

(54) SYSTEMS, DEVICES, AND METHODS FOR MULTI-OCCUPANT TRACKING

(71) Applicants: Ran Chang, Logan, UT (US); Chenguang Liu, Logan, UT (US); Aravind Dasu, Herndon, VA (US)

(72) Inventors: Ran Chang, Logan, UT (US); Chenguang Liu, Logan, UT (US); Aravind Dasu, Herndon, VA (US)

(73) Assignee: UTAH STATE UNIVERSITY, North Logan, UT (US)

(21) Appl. No.: 14/233,715

(22) PCT Filed: Jul. 19, 2012
(86) PCT No.: PCT/US2012/047464

§ 371 Date: Jan. 17, 2014

Related U.S. Application Data
(60) Provisional application No. 61/509,567, filed on Jul. 19, 2011.

(51) Int. Cl. G05D 27/02

(52) U.S. Cl. CPC G05D 27/02
USPC 700/90

(57) ABSTRACT

A computer implemented method and system for multi-occupant motion tracking and monitoring may include partitioning out of a controlled space one or more interior regions, tracking one or more occupants within the controlled space by collecting a sequence of images of the controlled space, determining from the sequence of images one or more contiguous pixel groupings corresponding to non-persistent motion (referred to as blobs), and generating one or more bounding boxes that encompass each of the contiguous pixel groupings.

### STATEMENT REGARDING FEDERALLY SPONSORED RESEARCH/DEVELOPMENT

This invention was made with government support under Grant Number EE0003114 awarded by the U.S. Department of Energy. The U.S. government has certain rights in the invention.

### RELATED APPLICATIONS

This application claims priority to U.S. Provisional Application No. 61/509,567 entitled “APPARATUS AND METHOD FOR MULTI-OCCUPANT MOTION TRACKING” filed on 19 Jul. 2011 for Ran Chang et al., the entirety of which is herein incorporated by reference. This application is also related in subject matter to PCT Application No. PCT/US12/41673, entitled “SYSTEMS AND METHODS FOR SENSING OCCUPANCY”, filed on Jun. 8, 2012 for Aravind Dasu et al., the entirety of which is herein incorporated by reference.

### BACKGROUND

The use of sensors to monitor the occupancy in rooms and to control various electronic devices or systems in rooms has been explored. However, improved methods, systems, and apparatuses are needed to increase for improved occupancy detection, building efficiency, operational convenience, and wide-spread implementation of control systems in living and workspaces. Various methods for sensing occupancy in a room have been explored.

### SUMMARY

The present disclosure in aspects and embodiments addresses these various needs and problems by providing a computer implemented method for multi-occupant motion tracking and monitoring. In embodiments, the method may include partitioning out of a controlled space an inner border region, an outer border region, and one or more interior regions. The computer implemented method may continue with tracking one or more occupants within the controlled space by collecting a sequence of images of a controlled space, determining from the sequence of images one or more contiguous pixel groupings corresponding to non-persistent motion (referred to as blobs), and generating one or more bounding boxes that encompass each of the contiguous pixel groupings. The method may also include inspecting a region of interest around each bounding box for non-persistent motion and updating each bounding box in accordance with the detected non-persistent motion. In some embodiments, the results from the multi-occupant tracking may drive a state machine with a plurality of triggers such as a motion disappear trigger, a workspace-locked trigger, an outer border region-unlocked trigger, an inner border region-locked trigger, a failsafe timeout trigger, or variations thereof.

The methods disclosed herein may also include adjusting conditions within the controlled space based on whether the controlled space, or a specific region thereof, is occupied. Corresponding devices and systems are also disclosed herein.

In some embodiments, a computer-implemented method for monitoring and controlling a controlled space may comprise: partitioning a controlled space into one or more regions; evaluating motion within the controlled space; and determining occupancy within the one or more regions.

In another embodiment, determining occupancy may comprise defining one or more new occupants; tracking the one or more occupants; and checking the status of the one or more occupants. Checking the status of the one or more occupants may comprise driving a state machine with a plurality of triggers corresponding to a location of the one or more occupants within a region of the controlled space. A trigger of the plurality of triggers may be selected from the group consisting of a motion disappear trigger, a workspace-locked trigger, a task-locked trigger, an outer border region-unlocked trigger, an inner border region-locked trigger, and a failsafe timeout trigger.

In another embodiment, a method may further comprise adjusting conditions within the controlled space based one or more triggers of the plurality of triggers being present in the state machine. Adjusting conditions may be selected from the group consisting of adjusting general lighting, adjusting task lighting, adjusting heating, adjusting ventilation, and adjusting cooling. The state machine may comprise one or more occupied states and one or more transition states. The transition states may comprise a first transition state corresponding to the outer border trigger and a second transition state corresponding to the inner border trigger.

In another embodiment, defining the one or more new occupants may comprise identifying one or more contiguous pixel groupings corresponding to non-persistent motion in a motion image of the controlled space; creating a bounding box surrounding the region of one or more contiguous pixel groupings corresponding to non-persistent motion; and adding the bounding box to an array of rectangles the define an occupant's motion.

In yet another embodiment, tracking the one or more occupants may comprise defining a region of interest within the controlled space that has the same center and is larger than a bounding box of an occupant; identifying one or more contiguous pixel groupings corresponding to non-persistent motion in a motion image of the controlled space; creating one or more rectangles that bound individual contiguous pixel grouping from the one or more contiguous pixel groupings; creating a single rectangle that bounds the one or more rectangles; and checking the status of the single rectangle.

A system for monitoring and controlling a controlled space may comprise a sensor interface module configured to collect a sequence of images of a controlled space; a partitioning module configured to partition out of the controlled space an inner border region, an outer border region, and one or more interior regions; a motion evaluation module configured to evaluate from the sequence of images of the controlled space whether non-persistent motion has occurred within the inner border region, the outer border region and the one or more interior regions; and an occupant detection module configured define, track, and check the status of one or more occupants in the controlled space.

A system for monitoring and controlling a controlled space may further comprise a state machine module with one or more triggers corresponding to a location of an occupant within specific regions of the controlled space. A trigger of the plurality of triggers may be selected from the group consisting of a motion disappear trigger, a workspace-locked trigger, a task-locked trigger, an outer border region-unlocked trigger, an inner border region-locked trigger, and a failsafe timeout trigger. The state machine may comprise one or more occupied states and one or more transition states. The transition states may comprise a first transition state corresponding to the outer border trigger and a second transition state corresponding to the inner border trigger.

A system for monitoring and controlling a controlled space may further comprise a conditions control module for adjusting conditions within the controlled space based on the one or more triggers. The conditions control module may be configured to make an adjustment selected from the group consisting of a general lighting adjustment, a task lighting adjustment, a heating adjustment, a ventilation adjustment, and a cooling adjustment.

The occupant detection module may further comprise a define new occupant module configured to: identify one or more contiguous pixel groupings corresponding to non-persistent motion in a motion image of the controlled space; create a bounding box surrounding the region of one or more contiguous pixel groupings corresponding to non-persistent motion; and add the bounding box to an array of rectangles the define an occupant's motion.

The occupant detection module may further comprise a track occupant module configured to: define a region of interest within the controlled space that has the same center and is larger than a bounding box of an occupant; identify one or more contiguous pixel groupings corresponding to non-persistent motion in a motion image of the controlled space; create one or more rectangles that bound individual contiguous pixel grouping from the one or more contiguous pixel groupings; create a single rectangle that bounds the one or more rectangles; and check the status of the single rectangle.

A system for monitoring and controlling a controlled space may comprise: a sensor configured to provide a sequence of images for a controlled space; a controller configured to: receive the sequence of images for the controlled space; partition out of the controlled space an inner border region, an outer border region, and one or more interior regions; identify, count, and track a position of one or more occupants within the controlled space or regions thereof; use the position of the one or more occupants to drive one or more triggers of a state machine; and a controllable device selected from the group consisting of a lighting device, a heating device, a cooling device, and a ventilation device.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIGS. 1, 2, and 3 are block diagrams illustrating various embodiments of an environment in which the present system, devices, and methods may be deployed.

FIG. 4A is a block diagram illustrating an example controller in accordance with the present disclosure.

FIG. 4B is a block diagram illustrating an example Motion Evaluation Module in accordance with the present disclosure.

FIG. 4C is a block diagram illustrating an example Occupant Detection Module in accordance with the present disclosure.

FIG. 5 is a schematic diagram of a digital image having a plurality of pixels.

FIG. 6 is a schematic diagram of an example difference image using the digital image of FIG. 5.

FIG. 7 is a schematic diagram of a corrected difference image.

FIG. 8 is a schematic diagram of an example persistence image based on the corrected difference image of FIG. 7.

FIG. 9 is a schematic diagram of an example motion history image based on the corrected difference image of FIG. 8.

FIG. 10 is a block diagram illustrating an example room from the environment of FIG. 1.

FIG. 11 is a block diagram showing a relationship of state machine triggers related to occupancy.

FIG. 12A is a flow diagram illustrating a portion of one example method of tracking the motion of one or more occupants in a room in accordance with the present disclosure.

FIG. 12B is a flow diagram illustrating another portion of one example method of tracking the motion of one or more occupants in a room in accordance with the present disclosure.

FIG. 12C is a flow diagram illustrating another portion of one example method of tracking the motion of one or more occupants in a room in accordance with the present disclosure.

FIG. 12D is a flow diagram illustrating another portion of one example method of tracking the motion of one or more occupants in a room in accordance with the present disclosure.

FIG. 13A is a flow diagram illustrating a portion of one example method of defining a new occupant in a room in accordance with the present disclosure.

FIG. 13B is a flow diagram illustrating another portion of one example method of defining a new occupant in a room in accordance with the present disclosure.

FIG. 14A is a flow diagram illustrating a portion of one example method of tracking the motion of an occupant in a room in accordance with the present disclosure.

FIG. 14B is a flow diagram illustrating another portion of one example method of tracking the motion of an occupant in a room in accordance with the present disclosure.

FIG. 14C is a flow diagram illustrating another portion of one example method of tracking the motion of an occupant in a room in accordance with the present disclosure.

FIG. 15A is a flow diagram illustrating a portion of one example method of performing a check split process in accordance with the present disclosure.

FIG. 15B is a flow diagram illustrating another portion of one example method of performing a check split process in accordance with the present disclosure.

FIG. 15C is a flow diagram illustrating another portion of one example method of performing a check split process in accordance with the present disclosure.

FIG. 16 is a flow diagram illustrating a portion of one example method of performing a split process in accordance with the present disclosure.

FIG. 17A is a flow diagram illustrating a portion of one example method of performing a recapture motion process in accordance with the present disclosure.

FIG. 17B is a flow diagram illustrating another portion of one example method of performing a recapture motion process in accordance with the present disclosure.

FIG. 18 is a flow diagram illustrating a portion of one example method of performing a check status process in accordance with the present disclosure.

FIG. 19 depicts a block diagram of an electronic device suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

Building efficiency and energy conservation is becoming increasingly important in our society. One way to conserve energy is to power devices in a controlled space only when those devices are needed. Many types of devices are needed only when the user is within a controlled space or in close proximity to such devices. One scenario is an office that includes a plurality of electronic devices such as lighting, heating and air conditioning, computers, telephones, etc. One aspect of the present disclosure relates to monitoring the presence of one or more occupants within a controlled space, and turning on and off at least some of the electronic devices based on the user's proximity to, or location within, the controlled space.

A multi-occupant tracking system, related devices, and methods may be used to determine whether an occupant is present within a given controlled space. A sequence of images of the controlled space may be used to determine one or more occupants' locations. The sequence allows motion data to be extracted from the images. The current and past motion from the images comprises what may be referred to as motion history. Occupancy information including the location of an occupant may be used, for example, so that lighting within the space may be adjusted to maximally reduce energy consumption. Another example is altering room heating or cooling or providing other environmental controls in response to determining the occupant's location.

### I. Controlled Space and Regions

In embodiments described herein, the space to monitor and sense occupancy is referred to as a controlled space, which may or may not have physical boundaries. For example, the controlled space may have one or more fixed walls with specific entrance locations or may be a region within a building that warrants monitoring and control separate from other portions of the building. Proper placement and size of borders and regions help provide the best operation of the occupancy sensor by allowing the method embodiments of the present disclosure to accurately predict when an occupant has entered or left the controlled space or regions within the controlled space. The borders and regions occupy enough pixels in the image such that the method can detect an occupant's presence within them.

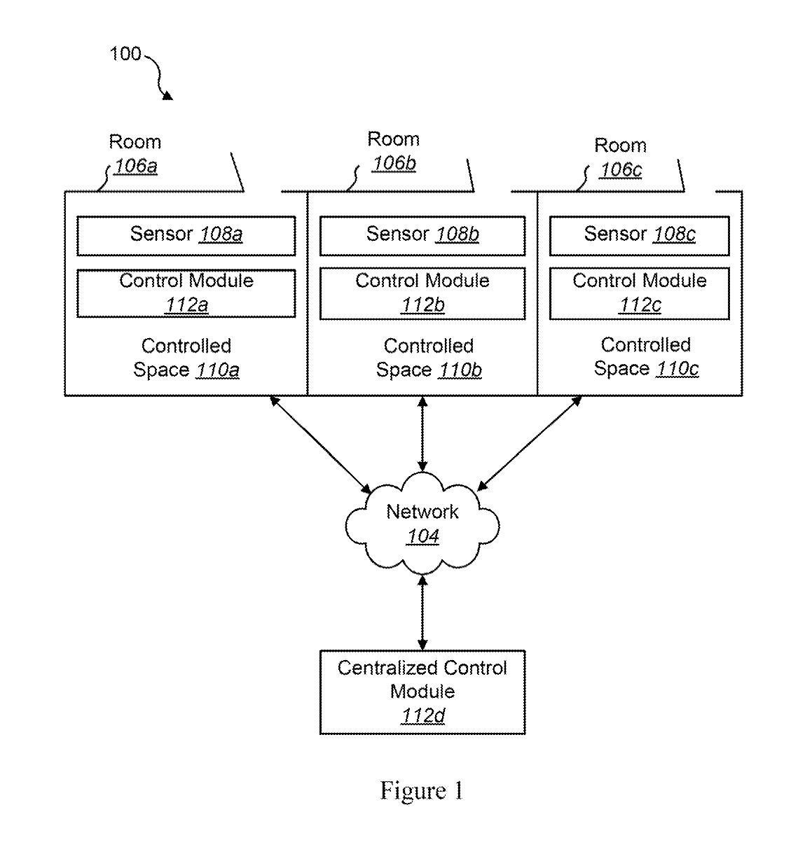

FIGS. 1, 2, 3, and 10 depict several example environments 100 in which the disclosed embodiments may be deployed. As depicted, the example environments 100 may include a network 104, one or more image sensors 108 which provide images of one or more controlled spaces 110 to one or more control modules 112 (112a-d). The control modules 112 may be localized (112a-c), centralized (112d), or distributed (112a-c). The control modules 112 may be interconnected by the network 104 (as shown in FIG. 1) or they may operate in isolation from other control modules 112.

The image sensors 108 provide images of the controlled spaces 110 where each pixel represents a measured value corresponding to a particular location (i.e. sampled area) within each controlled space. The measured values may correspond to luminosity or intensity over a particular region of the visible or non-visible spectrum. For example, an image sensor 108 may be a camera that with a CCD chip that is sensitive to visible or infrared light.

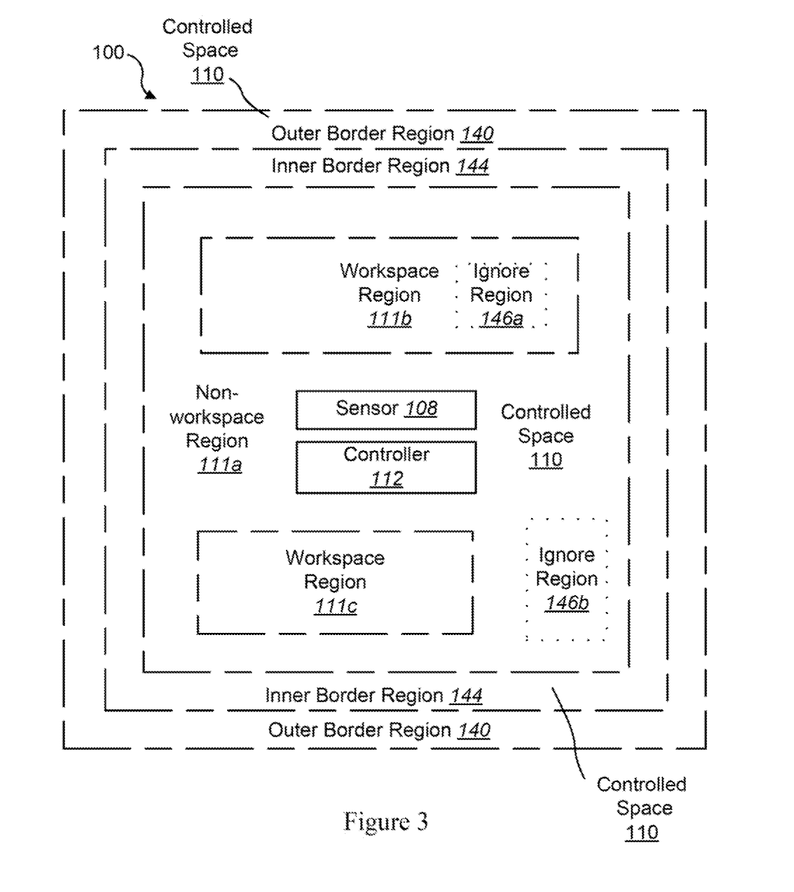

The controlled space 110 may be partitioned or bounded by one or more rooms 106. Alternately, as shown in FIG. 3, the controlled space may be an area or region that is separately monitored and controlled within a larger space such as a warehouse or factory. The controlled space 110 may also be partitioned into regions to facilitate improved occupancy detection and better control of conditions within particular regions within the controlled space 110.

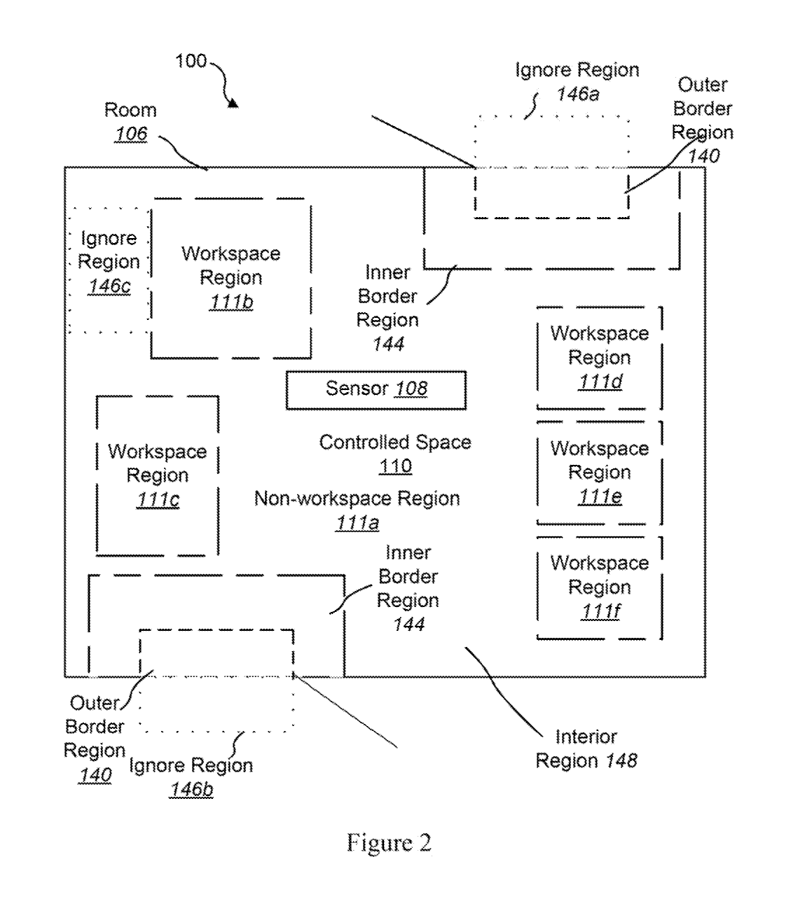

For example, FIG. 2 depicts a controlled space 110 corresponding to a room 106 that includes a non-workspace region 111a, various workspace regions 111b-111f, a pair of outer border regions 140 and inner border regions 144 that correspond to entries to the room 106, as well as several ignore regions 146a-c. Note that the ignore region 146a is immediately outside of the room 106 and may optionally be considered part of the controlled space 110. In contrast, yet conceptually similar, FIG. 3 depicts a controlled space 110 with no bounding walls that includes a non-workspace region 111a, a pair of workspace regions 111b and 111c, an outer border region 140 and an inner border region 144 that encompass the controlled space 110, and a pair of ignore regions 146a and 146b located within the controlled space.

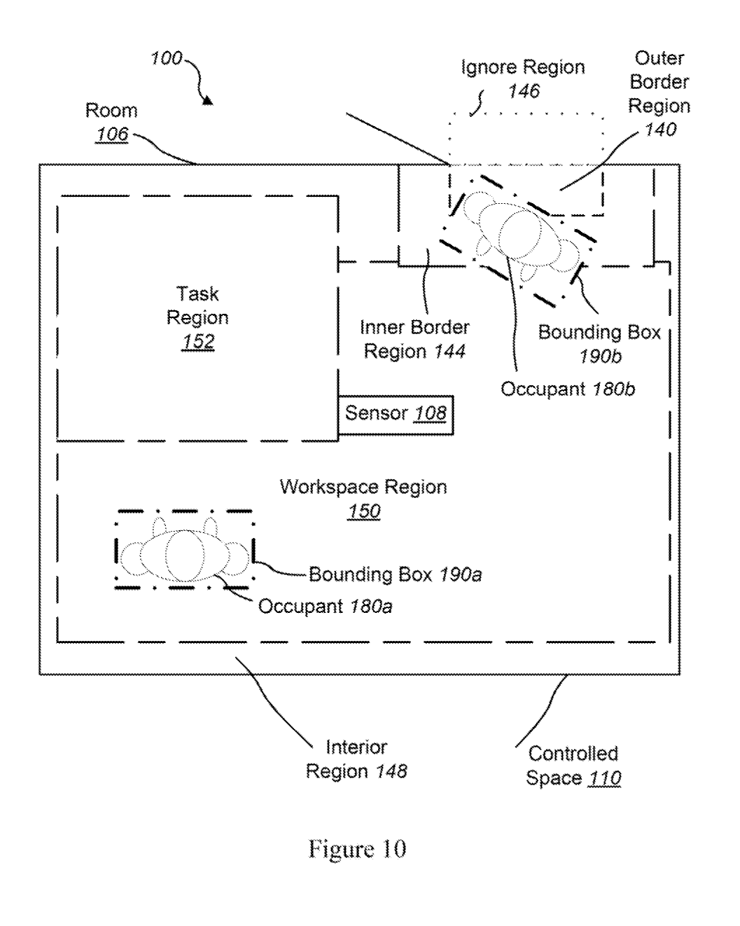

FIG. 10, referred to more detail below, depicts other regions within the controlled space 110, including a workspace region 150 and a task region 152. FIG. 10 also illustrates occupants 180a and b, and bounding boxes 190a and b.

### II. Control Module Overview

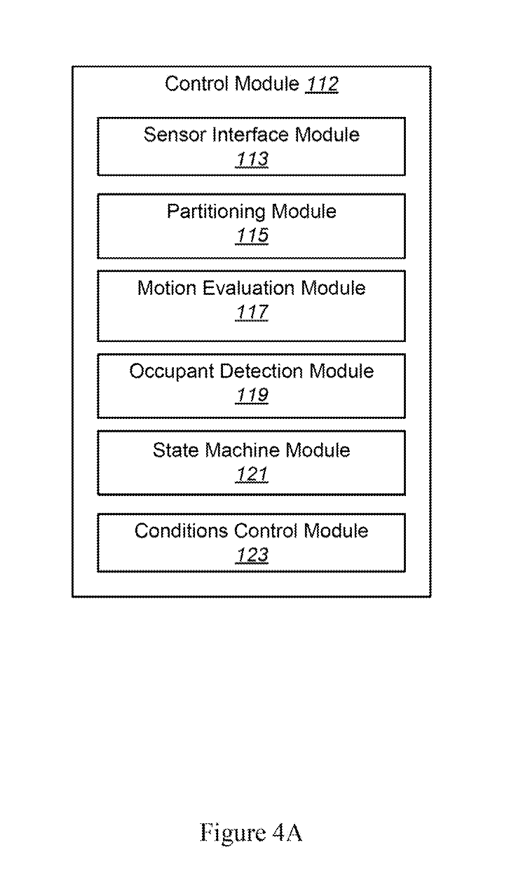

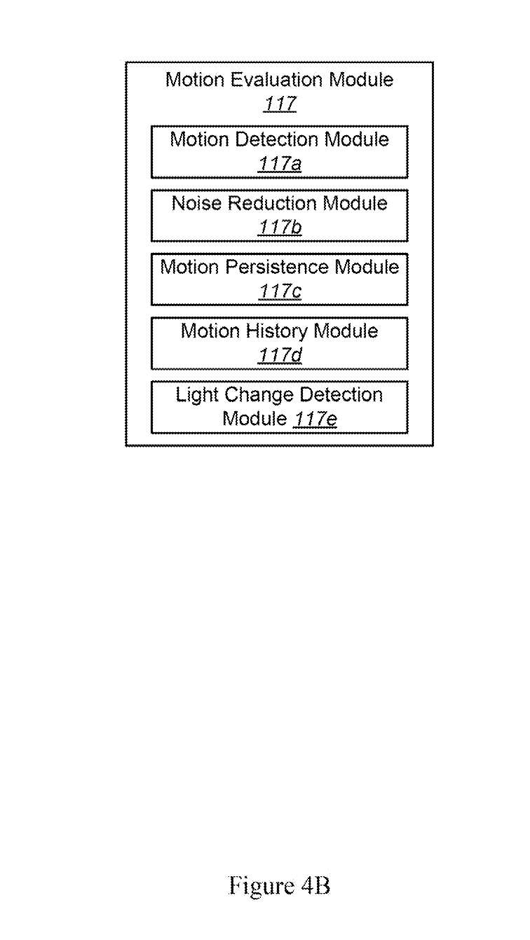

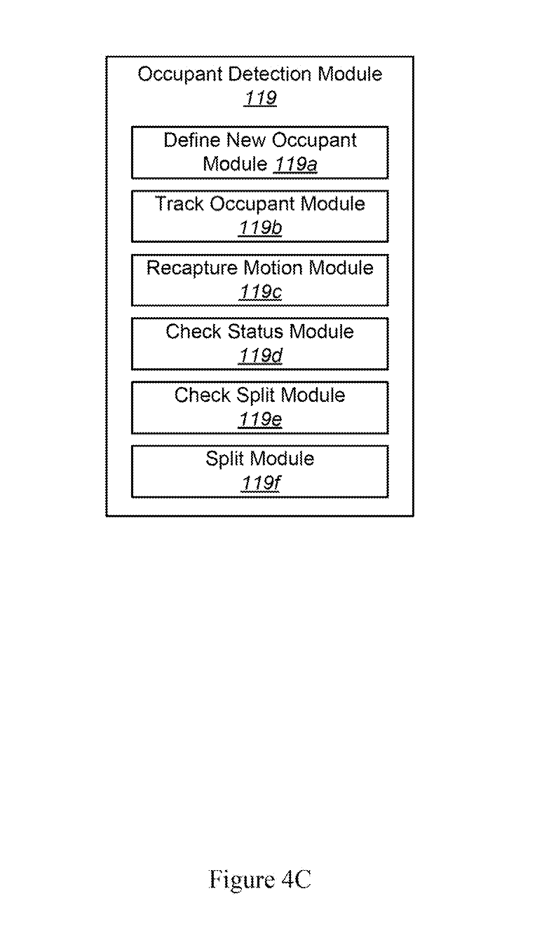

Referring to FIG. 4A, the control module 112 may include a plurality of sub-modules that perform various functions related to the disclosed systems, devices, and methods. As depicted, the controller 112 includes a sensor interface module 113, a partitioning module 115, a motion evaluation module 117, an occupant detection module 119, a state machine module 121, and a conditions control module 123.

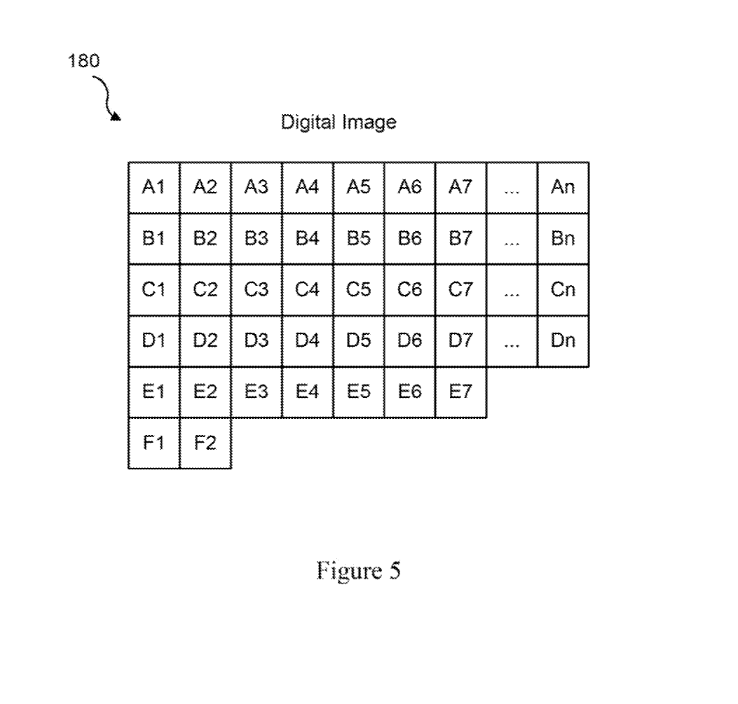

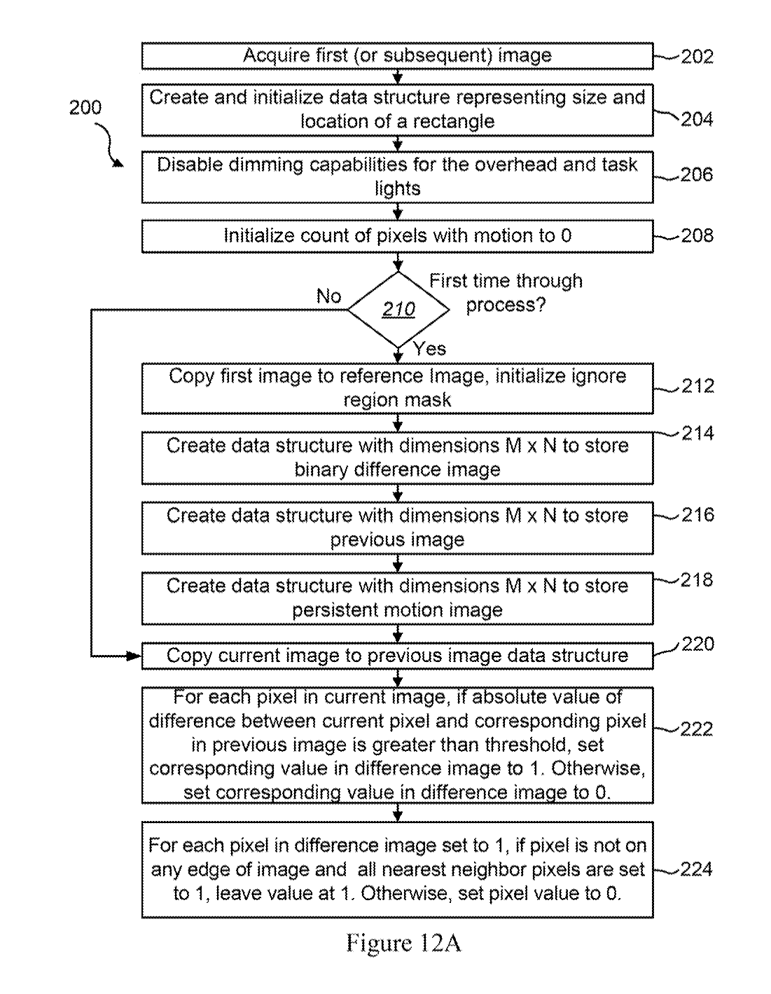

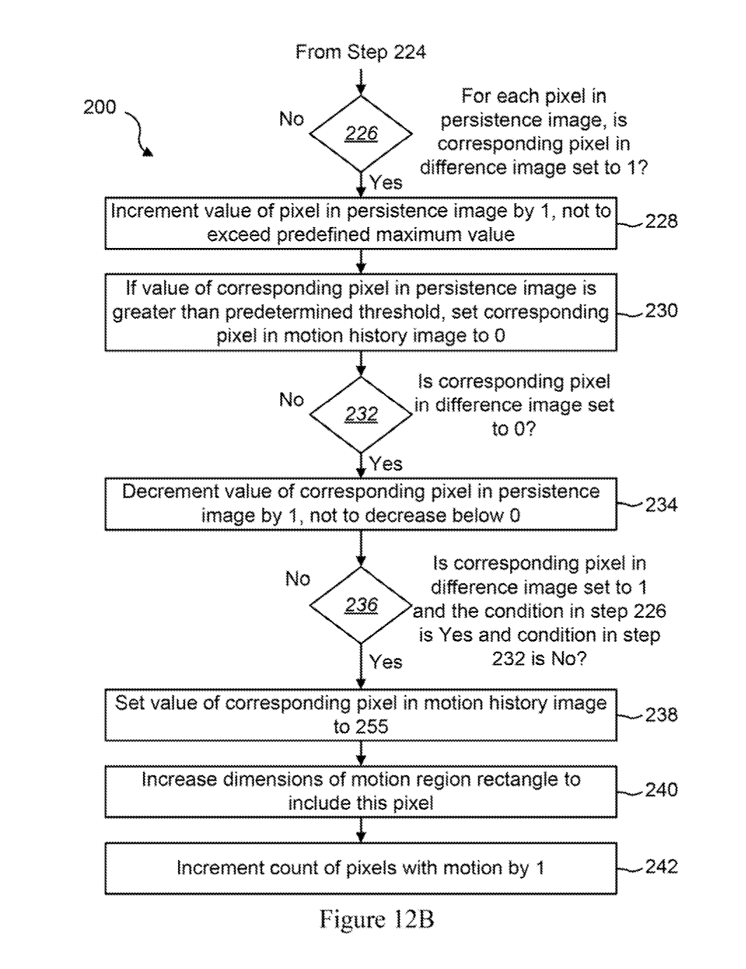

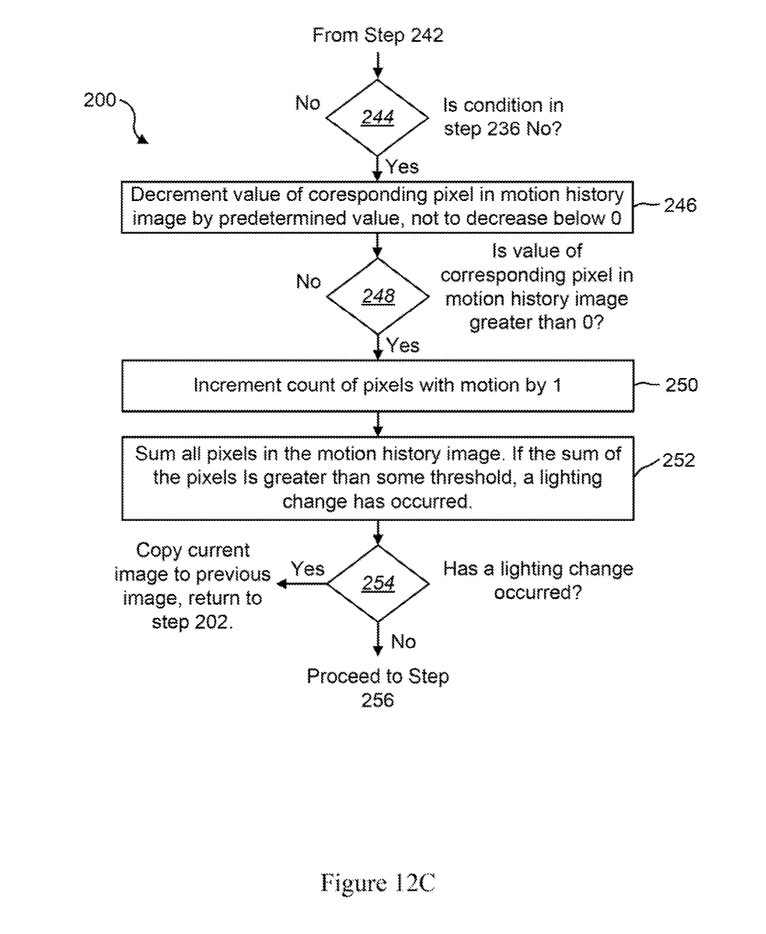

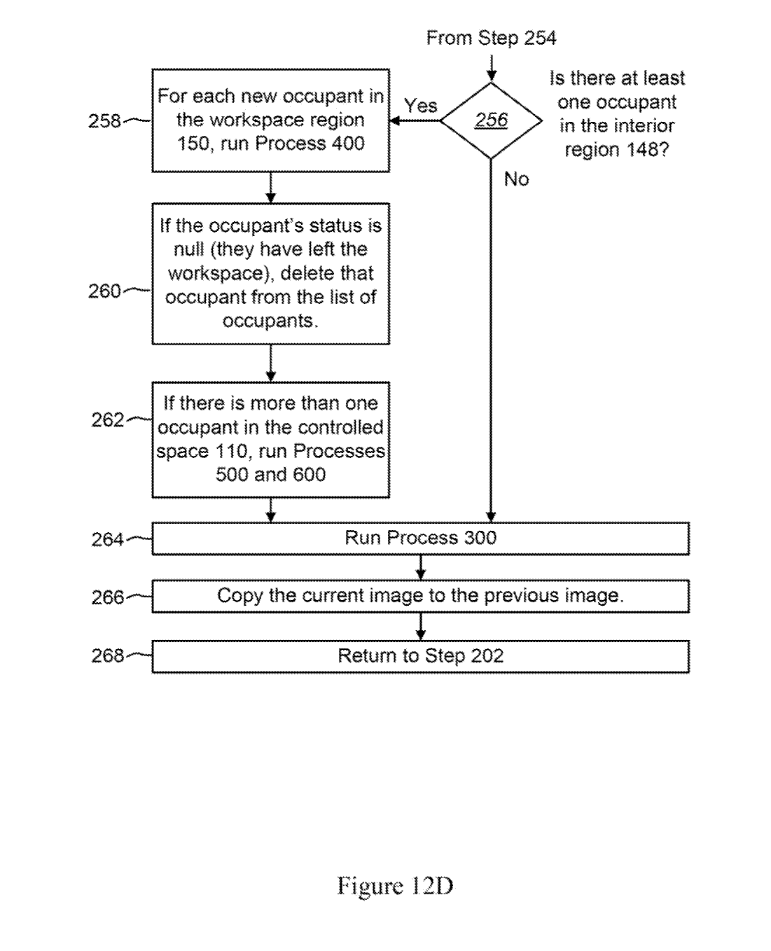

The motion evaluation module 117, the occupant detection module 119, and the state machine update module 121 may use the motion information described below with reference to FIGS. 5-11, and one or more of the methods of FIGS. 12-18, to track one or more occupants in a room and to control the conditions therein.

The sensor interface module 113 may collect a sequence of images for a controlled space 110 that are provided by an image sensor 108 or the like. The images may be composed of pixels that correspond to reflected or emitted light at specific locations within the controlled space. The reflected or emitted light may be visible or infrared.

The partitioning module 115 may partition the controlled space into a plurality of regions, shown in FIGS. 1-3 and 10, either automatically or under user or administrator control. The plurality of regions may facilitate detecting individuals entering or exiting the controlled space or specific areas or regions within the controlled space.

The motion evaluation module 117 may determine from the sequence of images whether non-persistent motion has occurred within the various regions over a time interval and thereby enable the occupant detection module 119 to identify, count, or track occupants within the controlled space or regions thereof.

The occupant detection module 119 may determine from the motion evaluation module the number and location of occupants within the controlled space or regions thereof.

The state machine module 121 may comprise a state machine (not shown) and a state machine update module (not shown) that drives the state machine with a plurality of triggers that indicate the position of one or more occupants within the controlled space.

The conditions control module 123 may control any electrical device. Exemplary control modules 121 may control lighting, heating, air conditioning, or ventilation within the controlled space 110 or regions thereof. For example, when an occupant enters the general workspace area, the conditions control module 121 may signal for the overhead lighting to turn on. Similarly, when an occupant enters the task region 152, the amount of lighting may be adjusted according to the amount of other light already present in the task region. Likewise, when an occupant leaves the task area but remains in the workspace region 150, the overhead lighting may be turned on fully and the task lighting may be reduced or turned off. Also, when an occupant leaves the general workspace area, all the lighting may be turned off and the heating or air conditioning adjusted to save energy by not conditioning the unoccupied room. In embodiments, adjusting a condition includes, for example, turning on or off, increasing or decreasing power, diming or brightening, increasing or decreasing the temperature, actuating electrical motors or components, open or close window coverings, open or close vents, or otherwise controlling an electrical component or system.

Various of the above modules are described in more detail in the section below.

### III. Motion Evaluation

Referring to FIG. 4B, the motion evaluation module 117 may leverage a number of sub-modules. In the depicted embodiment, the sub-modules include a motion detection module 117a, a noise reduction module 117b, a motion persistence module 117c, a motion history module 117d, and a light change detection module 117e. Various configurations may be possible for the motion evaluation module 117 that include more or fewer modules or sub-modules than those shown in FIG. 4B.

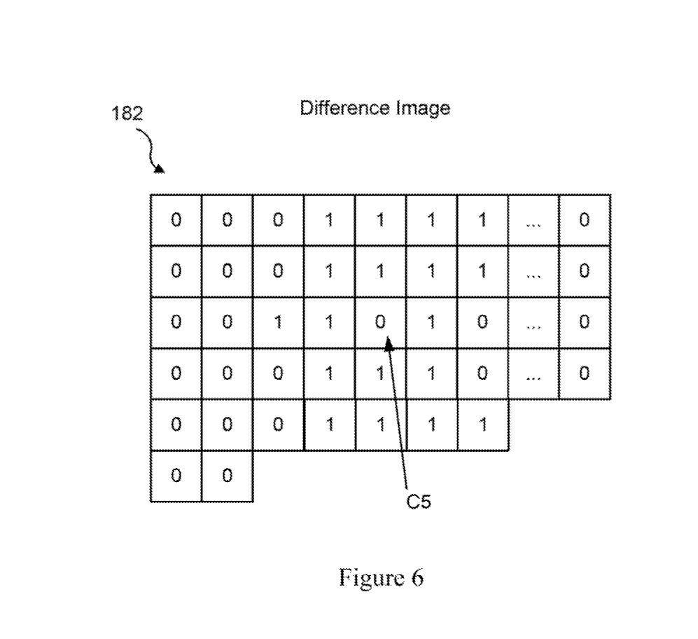

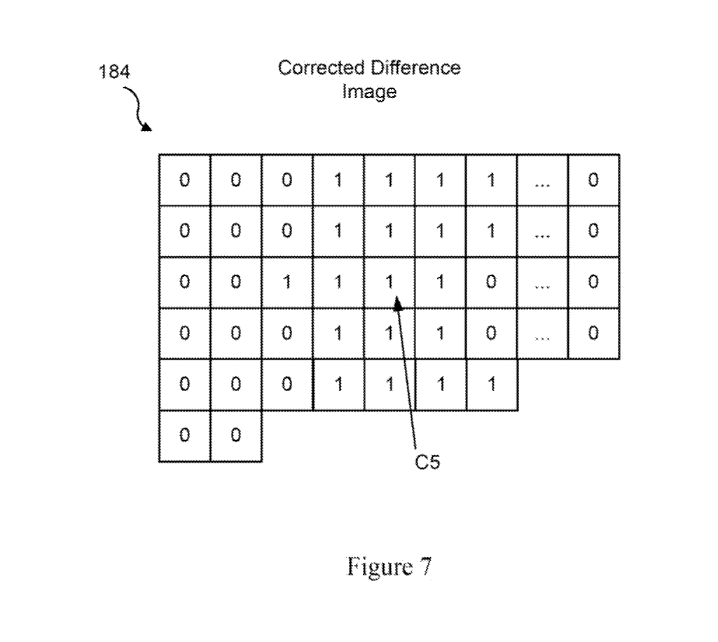

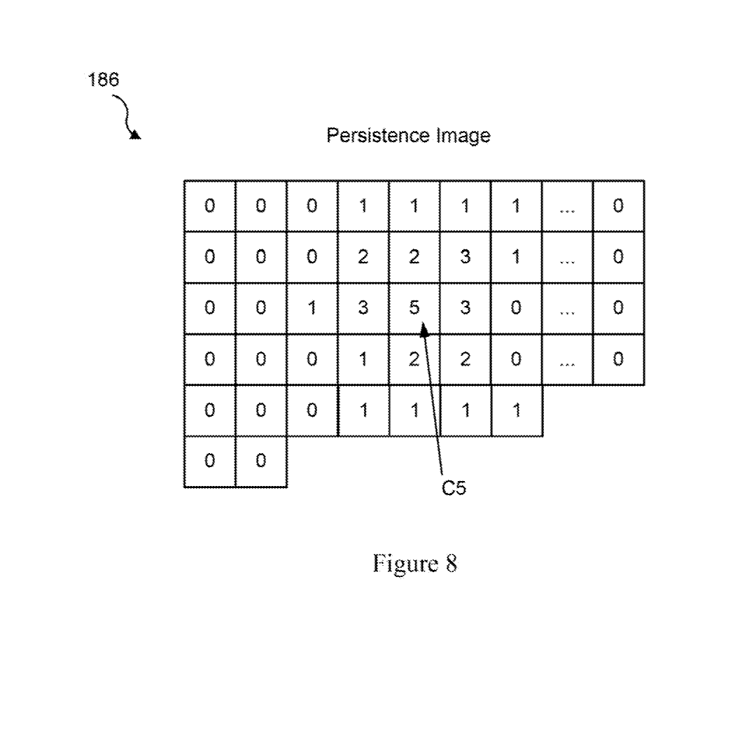

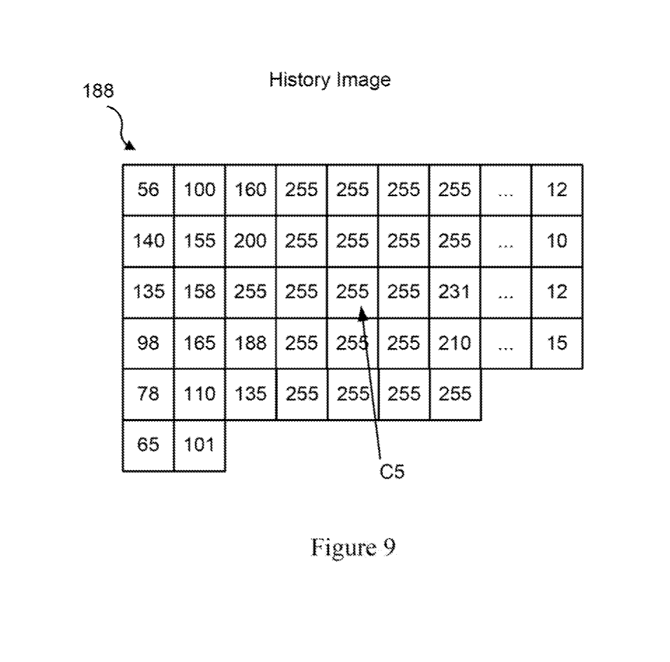

The motion detection module 117a may perform a comparison of past and current images and create the differencing image as described below with reference to FIG. 6. The noise reduction module 117b may create updates or corrections to the differencing image as described below with reference to FIG. 7. The motion persistence module 117c may help identify persistent movement that can be ignored and create a persistence image as described below with reference to FIG. 8. The motion history module 117d may create a history of detected motion and a motion history image as described below with reference to FIG. 9.

The light change detection module 117e may detect when a dramatic light change occurs and direct the system to acquire a new image rather than continue processing the current image to track occupants.

A. Motion Detection

1. Digital Image

Referring now to FIG. 5, a schematic digital image 180 is shown having a plurality of pixels labeled A1-An, B1-Bn, C1-Cn, D1-Dn, E1-E7 and F1-F2. The image 180 may include hundreds or thousands of pixels within the image. The image may be provided by the image sensor 108. In one embodiment, the image is converted to grayscale and delivered to the controller 112 for further processing.

2. Difference Image

Referring now to FIG. 6, an example difference image 182 is shown with a plurality of pixels that correspond to the pixels of the image 180 shown in FIG. 5. The difference image 182 represents the absolute value of the difference between two sequential images 180 that are collected by the image sensor 108. The two sequential images may be referred to as a previous or prior image and a current image. For each pixel in the difference image 182, the absolute value of the difference in luminance between the current image and the previous image is compared to a threshold value. In at least one embodiment, if the difference is greater than the threshold value, the corresponding pixel in the difference image 182 is set to 1 or some other predefined value. If the difference is less than the threshold value, the corresponding pixel in the difference image is set to 0 or some other preset value. The color black may correspond to 0 and white may correspond to 1. The threshold value is selected to be an amount sufficient to ignore differences in luminance values that should be considered noise. The resulting difference image 182 contains a 1 (or white color) for all pixels that represent motion between the current image and the previous image and a 0 (or black color) for all pixels that represent no motion. The pixel C5 is identified in FIG. 6 for purposes of tracking through the example images described below with reference to FIGS. 7-9.

B. Noise Reduction to Correct Difference Image

FIG. 7 shows a corrected difference image 184 that represents a correction to the difference image 182 wherein pixels representing motion in the difference image that should be considered invalid are changed because they are isolated from other pixels in the image. Such pixels are sometimes referred to as snow and may be considered generally as “noise.” In one embodiment, each pixel in the difference image 182 that does not lie on the edge of the image and contains the value 1, retains the value of 1 if the immediate neighboring pixel (adjacent and diagonal) is also 1. Otherwise, the value is changed to 0. Likewise, each pixel with a value of 0 may be changed to a value of 1 if the eight immediate neighboring pixels are 1, as shown for the pixel C5 in FIG. 7.

C. Motion Persistence and Image Erosion

FIG. 8 schematically represents an example persistence image 186 that helps in determining which pixels in the corrected difference image 184 may represent persistent motion, which is motion that is typically considered a type of noise and can be ignored. Each time a pixel in the corrected difference image 184 (or the difference image 182 if the correction shown in FIG. 7 is not made) represents valid motion, the value of the corresponding pixel in the persistence image 186 is incremented by 1. In some embodiments, incremental increases beyond a predetermined maximum value are ignored.

Each time a pixel in the corrected difference image 184 does not represent valid motion, the value of the corresponding pixel in the persistence image 186 is decremented. In one embodiment, the persistence image is decremented by 1, but may not go below 0. If the value of a pixel in a persistence image 186 is above a predetermined threshold, that pixel is considered to represent persistent motion. Persistent motion is motion that reoccurs often enough that it should be ignored (e.g., a fan blowing in an office controlled space). In the example of FIG. 8, if the threshold value were 4, then the pixel C5 would have exceeded the threshold and the pixel C5 would represent persistent motion.

D. Motion History

FIG. 9 schematically shows an example motion history image 188 that is used to help determine the history of motion in the controlled space. In one embodiment, each time a pixel in the current image 180 represents valid, non-persistent motion (e.g., as determined using the corrected difference image 184 and the persistence image 186), the corresponding pixel in the motion history image 188 is set to a predetermined value such as, for example, 255. Each time a pixel in the current image 180 does not represent valid, non-persistent motion, the corresponding pixel in the motion history image 188 is decremented by some predetermined value (e.g., 1, 5, 20) or multiplied by some predetermined factor (e.g., 0.9, ⅞, 0.5). This decremented value or multiplied factor may be referred to as decay. The resulting value of each pixel in the motion history image 188 indicates how recently motion was detected in that pixel. The larger the value of a pixel in the motion history image 188, the more recent the motion occurred in that pixel.

FIG. 9 shows a value 255 in each of the pixels where valid, non-persistent motion has occurred as determined using the corrected difference image 184 and the persistence image 186 (assuming none of the values in persistence image 186 have exceeded the threshold value). The pixels that had been determined as having either invalid or non-persistent motion (a value of 0 in images 184, 186) have some value less than 255 in the motion history image 188.

### IV. Occupant Tracking

Referring to FIG. 4C, the occupant detection module 119 may leverage a number of sub-modules. In the depicted embodiment, the occupant detection module 119 includes a define new occupant module 119a, a track occupant module 119b, a recapture motion module 119c, a check status module 119d, a check split module 119e, and a split module 119f. Various configurations may be possible for the occupant detection module 119 that include more or fewer modules or sub-modules than those shown in FIG. 4C.

A. Define New Occupant

The define new occupant module 119a may be configured to check for new occupants entering the controlled space by looking for contiguous pixel groupings corresponding to non-persistent motion, or blobs, in the motion history image but ignoring areas in the motion history image where other occupants are known to be. If a sufficiently sized blob or multiple blobs of motion overlap the inner border region, that blob or group of blobs may be considered a new occupant. In this instance, a new occupant may be added to the list of people who are in the controlled space or regions within the controlled space.

B. Occupant Tracking

The track occupant module 119b may be configured to track one or more occupants by monitoring a region of interest (ROI) that is larger than a bounding box surrounding a blob. Any blobs in the motion image that are detected within a surrounding area of a bounding box may be considered part of the occupant's motion.

C. Recapture Motion

The recapture motion module 119c may be configured to recapture an occupant's motion if no motion is detected for an occupant. In some embodiments, a motion image may be created using the current image and a reference image instead of the previous image. A reference image may show the workspace with no occupants. A search may be performed to find any blobs within the area of the motion image where the person was most recently located. Any blobs in the motion image that overlap the person's area by more than some predetermined threshold are considered to be part of the person's motion.

D. Check Status

The check status module 119d may be configured to track and update one or more occupants' status, which in some embodiments may comprises the occupants' location, an occupied region indicator for each occupant, a bounding box surrounding the occupants' motion, and a locked/unlocked flag for each occupant. The various elements of the occupants' status are described in more detail below.

E. Check Split and Split

The check split module 119e may be configured to evaluate pairs of occupants that are in close proximity such that their bounding boxes may be interpreted as one box. If two or more occupants' bounding boxes overlap, their blobs may be added to a list of blobs that need to be split into multiple occupants, and the number of resulting occupants may be incremented according to how many occupants need to be produced from the splitting.

The split module 119f may be configured to perform the splitting when the check split module 119e indicates a need to split a bounding box. In one embodiment, the split module 119f uses the k-means clustering algorithm, described below, to determine how to split the blobs. The k-means clustering algorithm takes as inputs the number of desired occupants and the list of blobs that should be split from the check split module 119e.

F. K-Means Clustering

As used herein k-means clustering is a method of cluster analysis which aims to partition n observations into k clusters in which each observation belongs to the cluster with the nearest mean. It is similar to the expectation-maximization algorithm for mixtures of Gaussians in that they both attempt to find the centers of natural clusters in the data as well as in the iterative refinement approach employed by both algorithms.

Given a set of observations (x₁, x₂, . . . , xₙ), where each observation is a d-dimensional real vector, k-means clustering aims to partition the n observations into k sets (k≦n) S={S₁, S₂, . . . , Sₖ} so as to minimize the within-cluster sum of squares (WCSS):

$$\begin{matrix}argmin \\ s\end{matrix} {\sum }_{i = 1}^{k} {\sum }_{{x}_{j} ∈ {S}_{i}} {‖ {x}_{j} - {μ}_{i} ‖}^{2} \qquad Equation 1$$

Where μᵢ is the mean of points in Sᵢ.

Given an initial set of k means m₁⁽ⁱ⁾, . . . , mₖ⁽ⁱ⁾, the algorithm proceeds by iterating between two steps: an assignment step and an update step.

An assignment step assign each observation to the cluster with the closest mean:

Sᵢ^{(t)}={xⱼ:∥xⱼ−mᵢ^{(t)}∥≦∥xⱼ−mᵢ_{ⁿ}^{(t)}∥ for all iⁿ=1, . . . , k} Equation 2

An update step calculates the new means that becomes the centroid of the observations in the cluster:

$${m}_{i}^{( t + 1 )} = \frac{1}{\vert {S}_{i}^{( t )} \vert} {\sum }_{{x}_{j} ∈ {S}_{i}^{( t )}} {x}_{j} \qquad Equation 3$$

The algorithm is deemed to have converged when the assignments no longer change.

Commonly used initialization methods are Forgy and Random Partition. The Forgy method randomly chooses k observations from the data set and uses these as the initial means. The Random Partition method first randomly assigns a cluster to each observation and then proceeds to the update step, thus computing the initial means to be the centroid of the cluster's randomly assigned points. The Forgy method tens to spread the initial means out, while Random Partition places all of them close to the center of the data set.

Other methods known to those skilled in the art could be utilized in place of the k-means clustering described above. Fuzzy C-Means Clustering is a soft version of K-means, where each data point has a fuzzy degree of belonging to each cluster. The expectation-maximization algorithm (EM algorithm) maintains probabilistic assignments to clusters, instead of deterministic assignments, and multivariate Gaussian distributions instead of means.

### V. Region Partitioning

Proper placement in sizing of the regions within a controlled space may help optimize operation of the monitoring and controlling systems devices and methods discussed herein. Proper placement and size of the borders may allow the system to more accurately decide when an occupant has entered or departed a controlled space. The borders may occupy enough pixels in the collected image such that the system may detect the occupant's presence within each of the regions.

Referring again to FIG. 10, a further step may be to evaluate the number of pixels that represent motion in particular regions in the image. Assuming the image 180 represents an entire footprint of the room 106, the region in the image may include outer border region 140, inner border region 144, workspace region 150, task region 152, and ignore regions 146. Outer border region 140 is shown in FIG. 10 having a rectangular shape and may be positioned at the door opening. Outer border region 140 may be placed inside the controlled space 110 and as near the doorway as possible without occupying any pixels that lie outside of the doorway within the ignore region 146. Typically, a side that is positioned adjacent to the door opening is at least as wide as the width of the door.

Inner border region 144 may be placed around at least a portion of the periphery of outer border region 140. Inner border region 144 may surround all peripheral surfaces of outer border region 140 that are otherwise exposed to the controlled space 110. Inner border region 144 may be large enough that the system can detect the occupant's presence in inner border region 144 separate and distinct from detecting the occupant's presence in outer border region 140.

The room 106 may include one or more ignore regions 146. In the event the sensor 108 is able to see through the entrance of the room 106 (e.g. through an open door) into a space beyond outer border region 140 or see a region is associated with the persistent movement of machinery or the like, movement within the one or more ignore regions 146 may be masked and ignored.

The ignore regions 146 may also be rectangular in shape (or any other suitable shape) and may be placed at any suitable location such as adjacent to the outer border region 140 and outside the door opening. The ignore regions 146 may be used to mask pixels in the image (e.g., image 180) that are outside of the controlled space 110 or associated with constant persistent motion or specified by a user or administrator, but that are visible in the image. Any motion within the ignore regions 146 may be ignored.

### VI. Occupancy Determination

A state machine may be updated using triggers generated by tracking an occupant's motion in or near each region shown in FIG. 10. Examples of triggers and their associated priority may include a motion disappear trigger, a workspace region-locked trigger, a task-locked trigger, an outer border region-unlocked trigger, an inner border region-locked trigger, and a failsafe timeout trigger. The motion disappear, workspace, and failsafe timeout triggers may represent occupied (or unoccupied) states and the border region triggers may represent transition states. Each enabled trigger is evaluated in order of decreasing priority. If, for example, the currently evaluated trigger is the workspace motion-locked trigger, the workspace motion updates the state machine and all other enabled triggers are discarded. This particular priority may be implemented because workspace motion makes any other motion irrelevant.

In one embodiment, to update the state machine, the check status module may calculate the number of pixels of a moving occupant's bounding box that overlap the inner border region 144, the outer border region 140, the task region 152, or the workspace region 150. If most of the overlapping pixels are in the outer border region, the occupant status may be set to ‘outer-border region, unlocked’. If most of the overlapping pixels are in the inner border region, the occupant's status may be set to ‘inner-border region, locked’. If most of the overlapping pixels are in the task region, the occupant's status may be set to ‘task-locked’. If most of the overlapping pixels are in the task region, the occupant's status may be set to ‘workspace region-locked’.

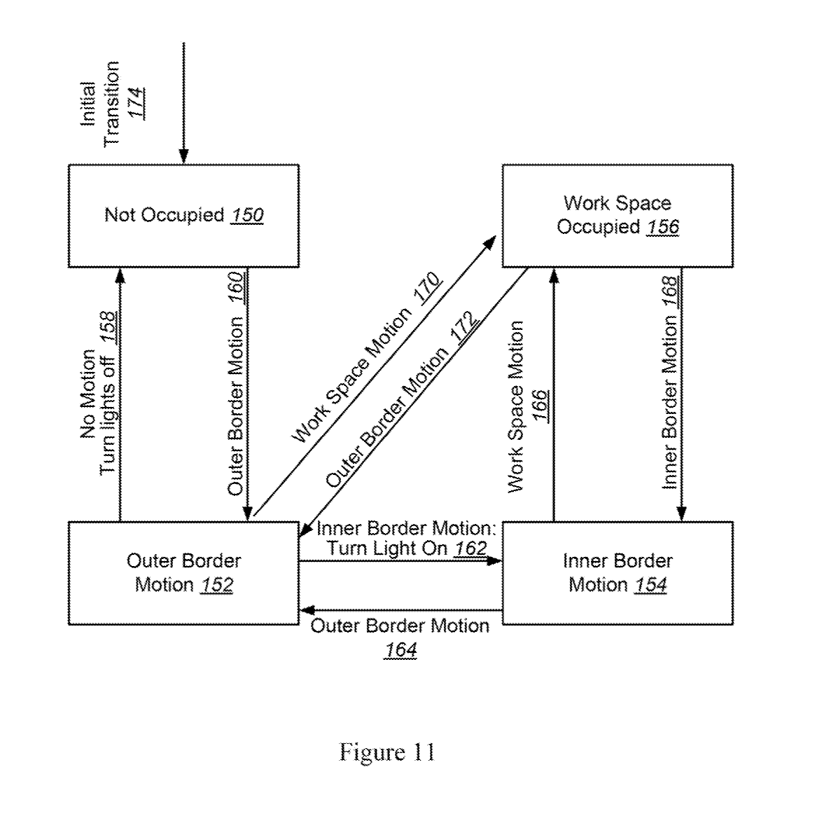

A state machine may be used to help define the behavior of the image sensor and related system and methods. As shown in FIG. 11, the state machine may include one or more occupied states and one or more transition states. In the depicted example, there are four states in the state machine: not occupied, outer border motion, inner border motion, and work space occupied. Other examples may include more or fewer states depending on, for example, the number of borders established in the controlled space. The not occupied state may be valid initially and when the occupant has moved from the outer border region to somewhere outside of the controlled space. If the occupant moves from the outer border region to somewhere outside of the controlled space, the controlled space environment may be altered (e.g., the lights turned off). The outer border region motion state may be valid when the occupant has moved into the outer border region from either outside the controlled space or from within the interior space. The inner border region motion state may be valid when the occupant has moved into the inner border region from either the outer border region or the interior space. If the occupant enters the inner border region from the outer border region, the controlled space environment may be altered (e.g., the lights turned on). A controlled space occupied state may be valid when the occupant has moved into the interior or non-border space from either the outer border region or the inner border region.

FIG. 11 schematically illustrates an example state machine having the four states described above. The state machine is typically set to not occupied 150 in response to an initial transition 174. The outer border region motion state 152, the inner border region motion state 154, and work space occupied state 156 are interconnected with arrows that represent the movement of the occupant from one space or border to another.

A motion ended trigger may result, for example, in lights being turned off 158, and may occur as the occupant moves from outer border region 140 and into ignore region 146. An outer border region motion trigger 160 may occur as the occupant moves from outside of the controlled space 110 and into the outer border region 140. An inner border region motion trigger 162, resulting, for example, in turning a light on, may occur as the occupant moves from outer border region 140 to inner border region 144. An outer border region motion trigger 164 may occur as the occupant moves from the inner border region 144 to the outer border region 140. A work space motion trigger 166 may occur as the occupant moves from inner border region 144 to the work space 150. An inner border region motion trigger 168 may occur when an occupant moves from the work space region 150 to the inner border region 144. A work space motion trigger 170 may occur as the occupant moves from outer border region 140 to the work space region 150. An outer border region motion trigger 172 may occur as the occupant moves from the work space region 150 to the outer border region 140.

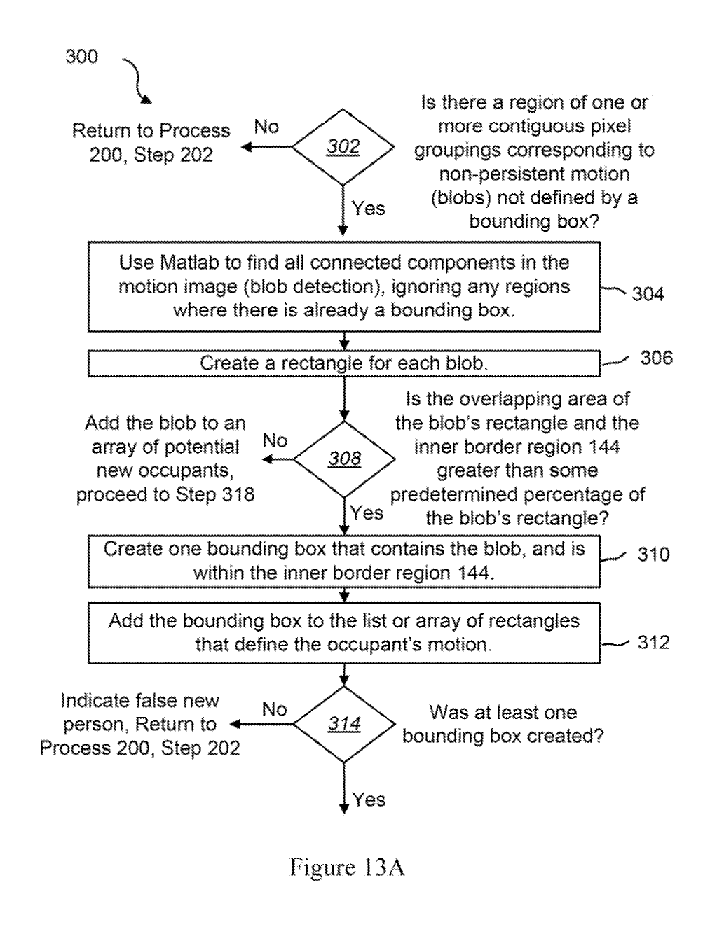

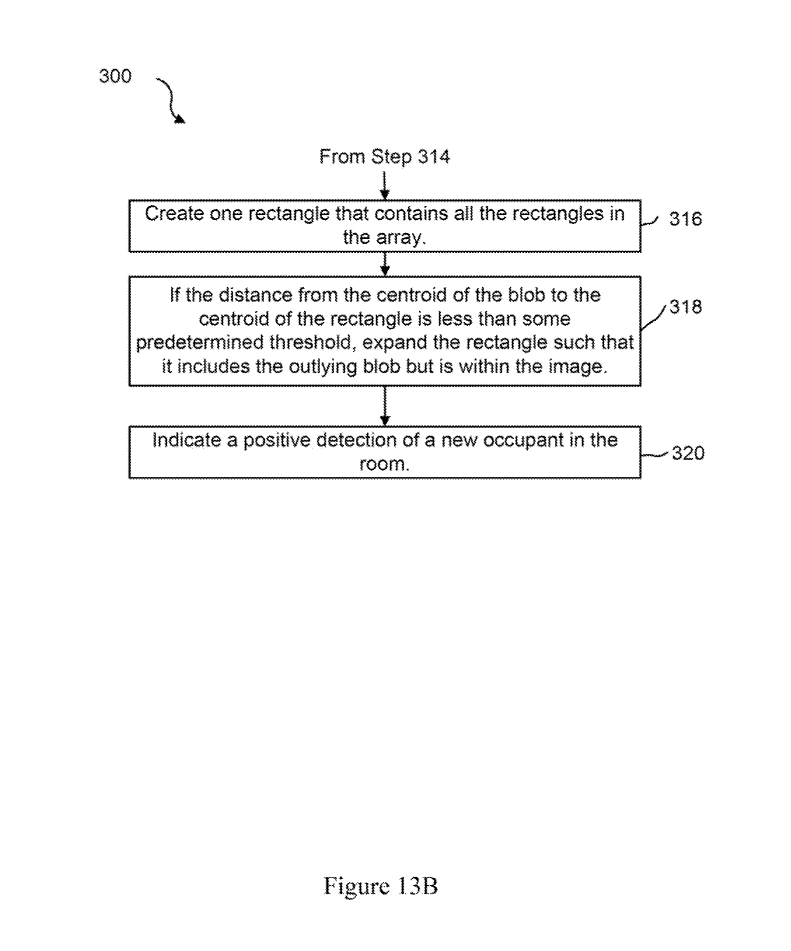

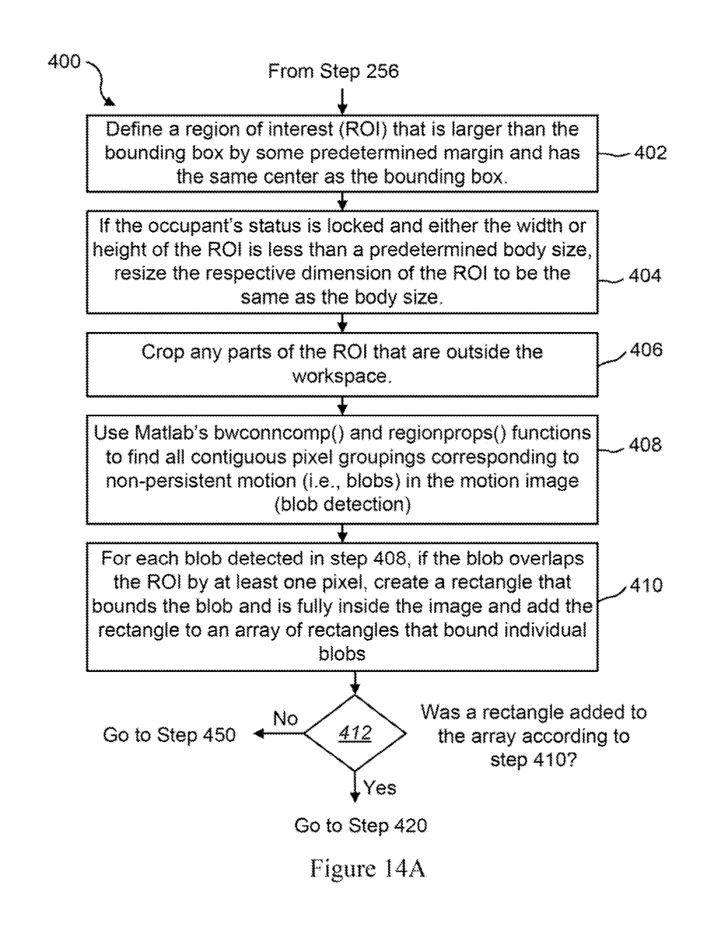

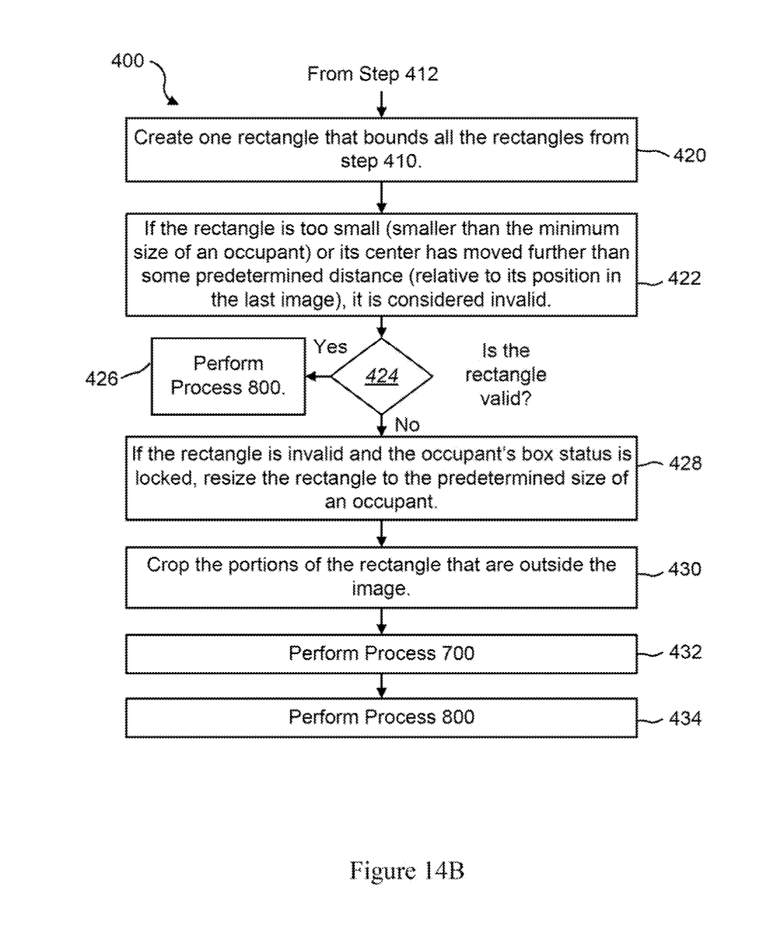

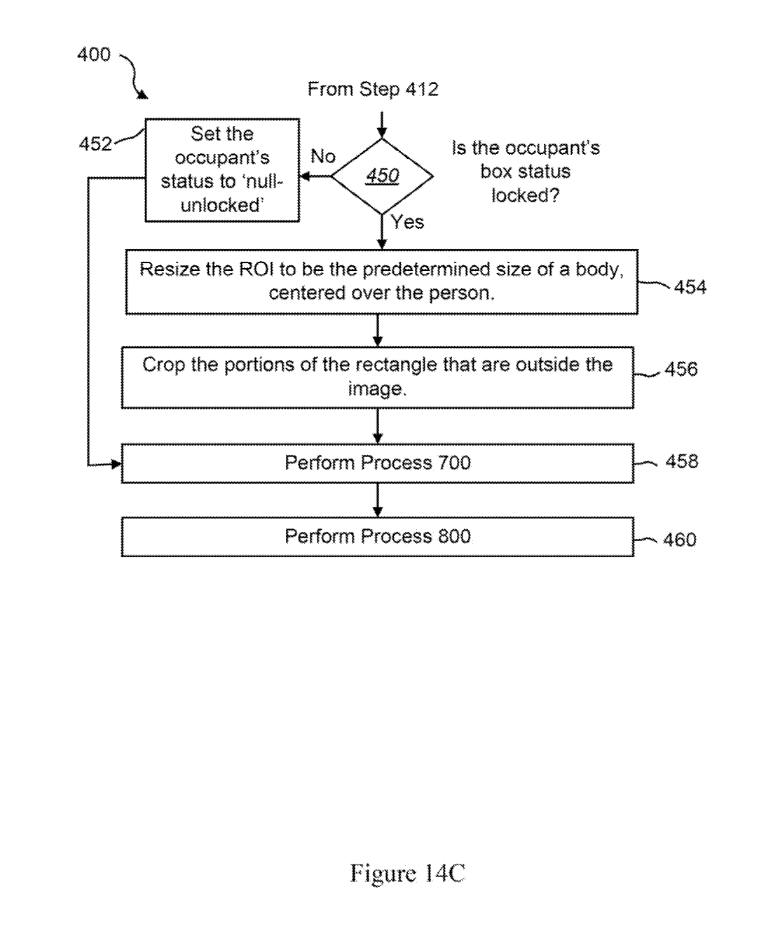

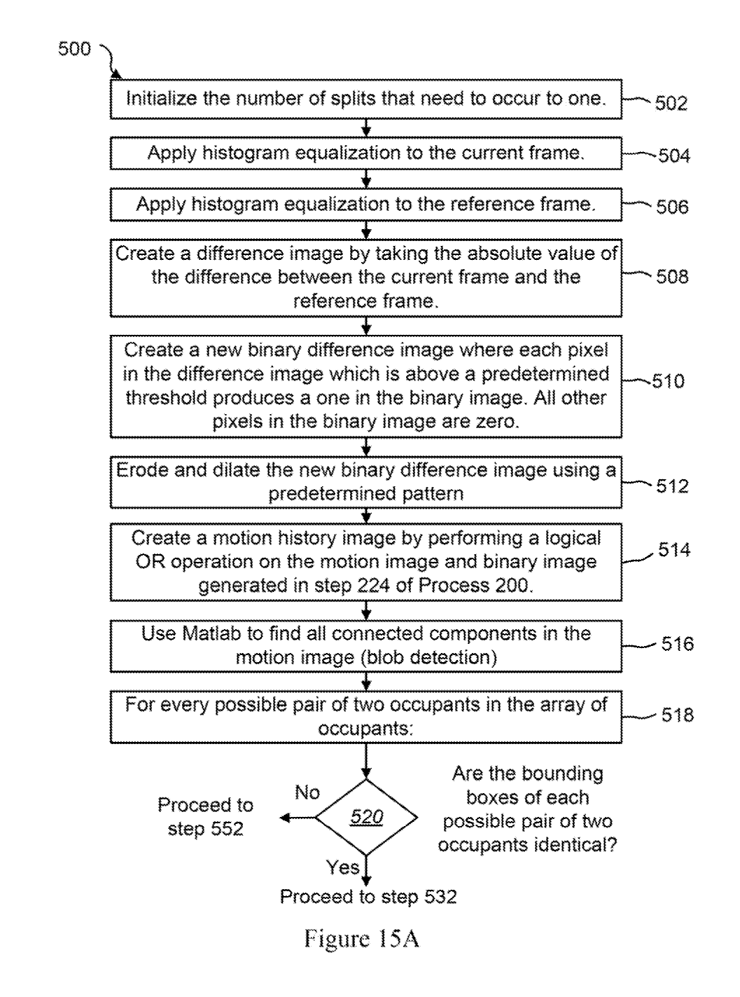

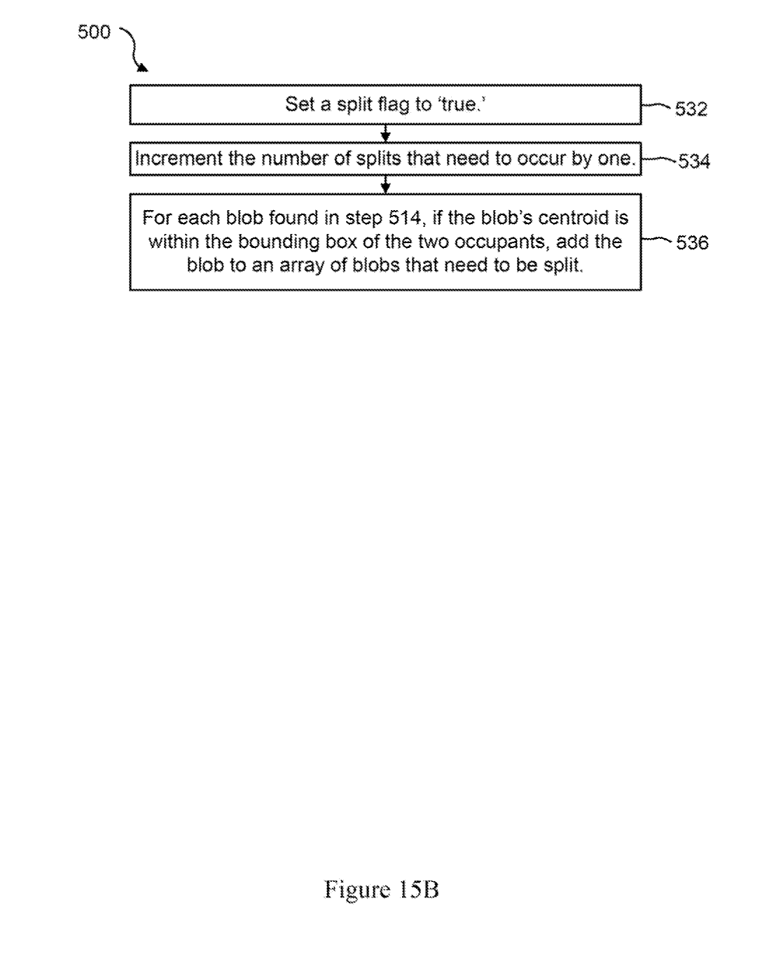

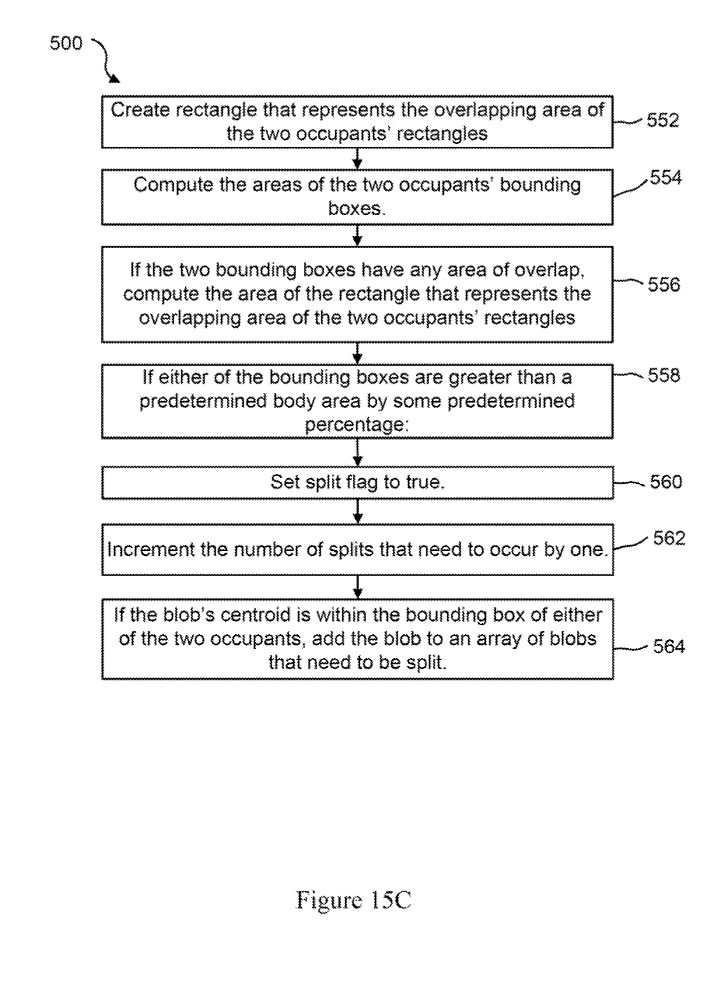

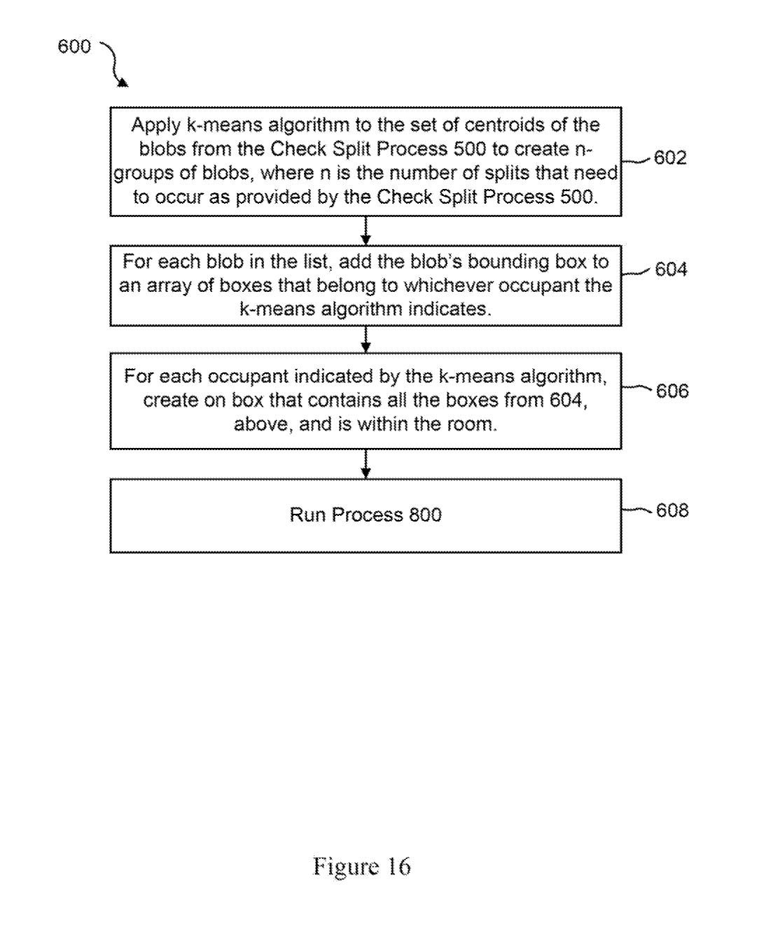

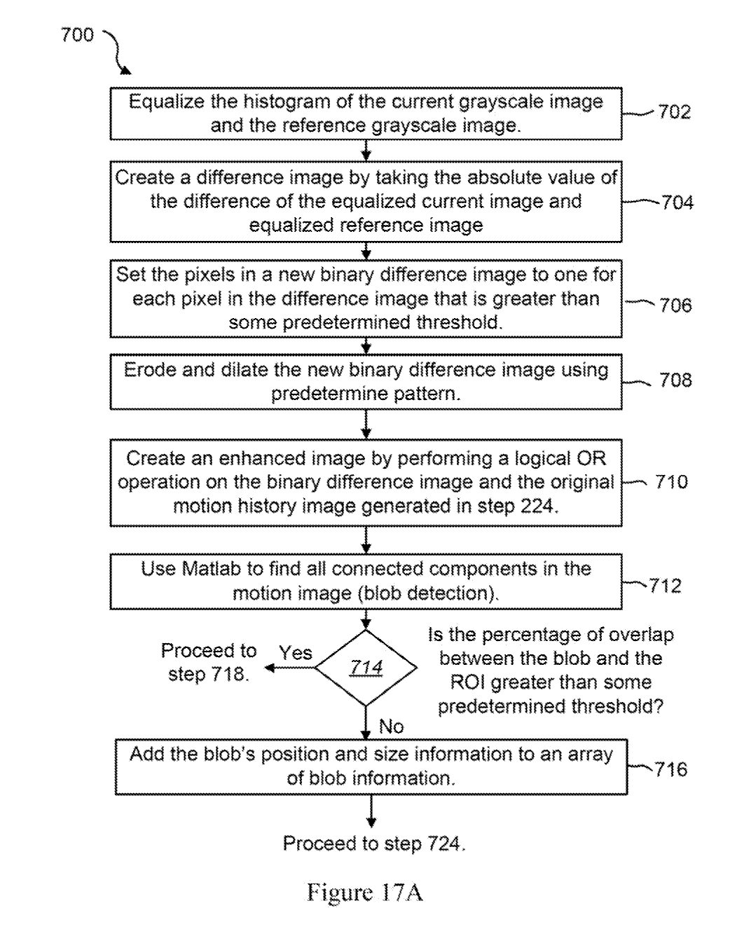

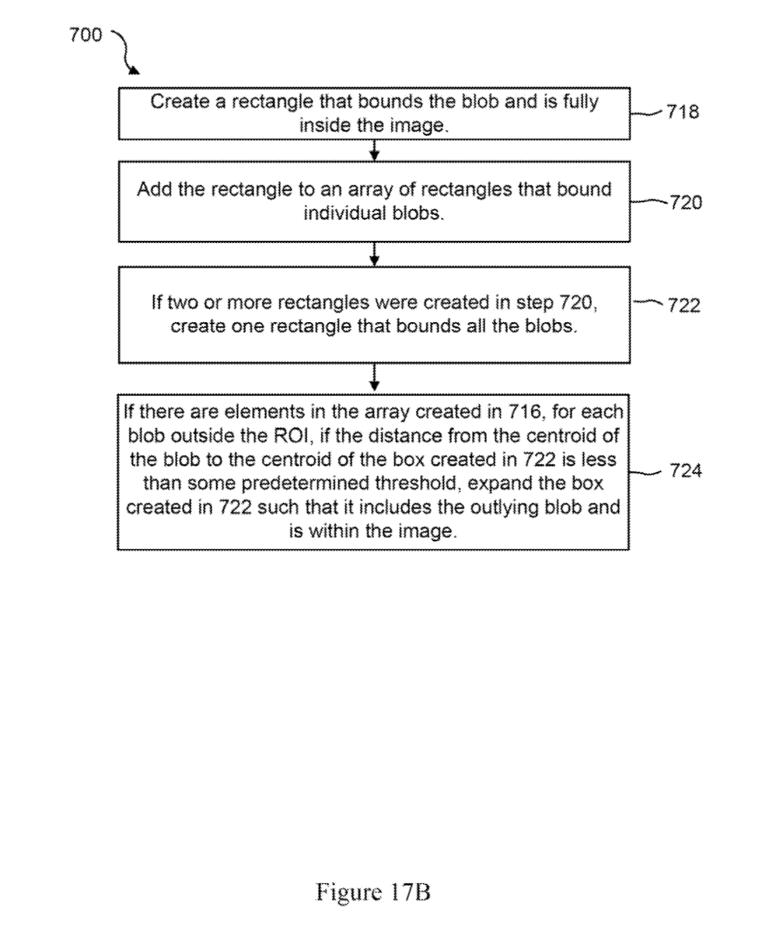

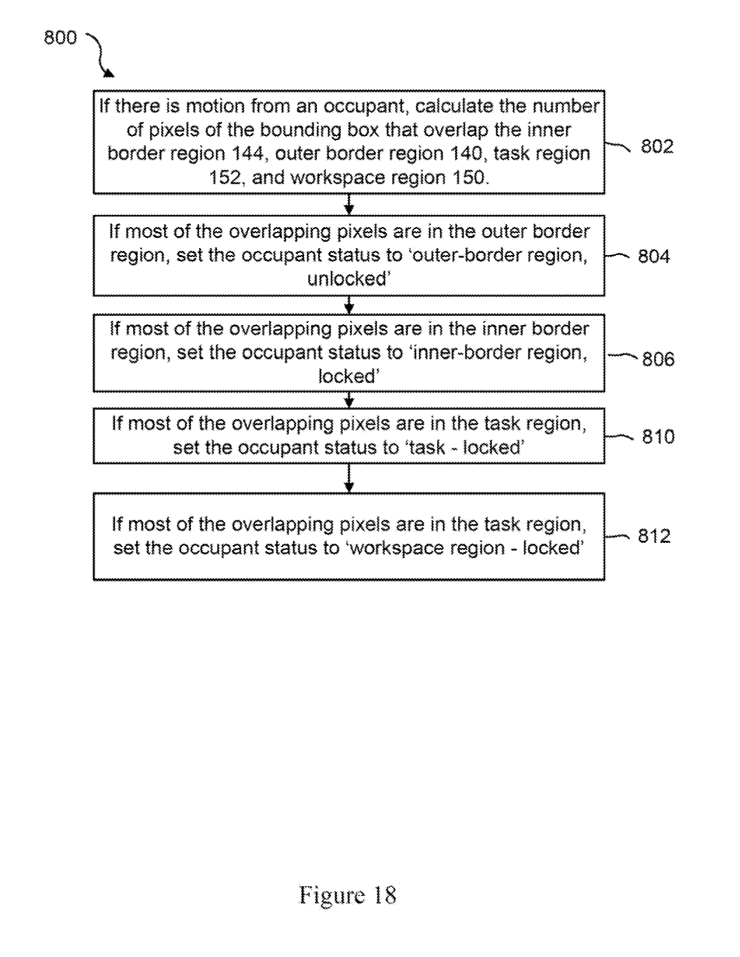

FIGS. 12A-D further illustrate a detailed method 200 for determining occupancy of a controlled space or regions therein from a series of images and state machine logic. The example process illustrated in FIGS. 12A-D incorporate all or portions of the processes illustrated in FIGS. 13A-B, 14A-C, 15A-C, 16, 17A-B, and 18. FIGS. 13A-B illustrate an example process for finding and defining a new occupant in the controlled space. FIGS. 14A-C illustrate an example process for tracking an occupant and updating an occupant's bounding box and locked/unlocked status. FIGS. 15A-C illustrate an example process for determining whether an occupant's bounding box should be split into two or more bounding boxes for more accurate occupant tracking. FIG. 16 illustrates an example process for splitting an occupant's bounding box. FIGS. 17A-B illustrate an example process for recapturing an occupant's motion if the motion has been lost. FIG. 18 illustrates an example process for checking the status of an occupant within the controlled area. The sub-processes described herein may be combined with other processes for determining occupancy and controlling conditions in a controlled space.

FIG. 12A shows the method 200 beginning with acquiring a first image (or subsequent image) 202 M pixels wide by N pixels high and initializing the count of pixels with motion to 0 in the step 204. Step 206 disables the dimming capabilities for the overhead and task area lighting and step 208 initializes the count of pixels with motion to 0. A step 210 determines whether this is the first time through the method. If so, the method moves onto step 212 initializing an ignore region mask. If not, the system moves to step 220 and skips the steps of creating various data structures and the ignore mask region in steps 212-218.

Step 214 includes creating a data structure with dimensions M×N to store a binary difference image. Step 216 includes creating a data structure with dimensions M×N to store the previous image. Step 218 includes creating a data structure with dimensions M×N to store a persistent motion image. The following step 220 includes copying a current image to the previous image data structure. In step 222, for each pixel in the current image, if an absolute value of difference between the current pixel and corresponding pixel in a previous image is greater than a threshold, a corresponding value is set in a difference image to 1. Otherwise, a corresponding value is set in a difference image to 0. The step 224 includes leaving the value of a pixel at 1, for each pixel in the difference image set to 1, if the pixel is not on any edge of the image and all nearest neighbor pixels (e.g., the eight neighbor pixels) are set to 1. Otherwise, the pixel value is set at 0.

FIG. 12B shows further example steps of method 200. The method 200 may include determining for each pixel in the persistence image whether the corresponding pixel in the difference image is set to 1 in a step 226. Further step 228 includes incrementing the value of the pixel in the persistence image by 1, and not to exceed a predefined maximum value. If the value of the corresponding pixel and the persistence image is greater than a predetermined threshold, the corresponding pixel is set in the motion history image to 0 in a step 230.

A step 232 includes determining whether a corresponding pixel in a difference image is set to 0. If so, step 234 includes decrementing a value of the corresponding pixel in a persistence image by 1, and not to decrease below the value of 0. If a corresponding pixel in the difference image is set to 1 and the condition in step 226 is yes and the condition in step 232 is no, then a further step 238 includes setting a value of the corresponding pixel in a motion history image 255 or some other predefined value. A step 240 includes increasing the dimension of the motion region rectangle to include this pixel. An increment count of pixels with motion is increased by 1 in the step 242.

FIG. 12C shows potential additional steps of method 200 including step 244 of determining whether the condition in step 236 is no. If so, a step 246 includes decrementing a value of the corresponding pixel in the motion history image by a predetermined value, and not to decrease below a value of 0. If the value of the corresponding pixel in the motion history image is greater than 0, according to a step 248, a step 250 includes incrementing a count of pixels with motion by 1. A step 252 includes increasing a dimension of the motion region rectangle to include this pixel.

In step 254, the process determines whether a significant lighting change has occurred by summing all the pixels in the motion history image and determining whether that sum is greater than some threshold value. If the sum is greater than some threshold value, a lighting change has occurred, the current image is copied to the previous image and the process returns to step 202.

In FIG. 12D, if a lighting change has not occurred, the process continues to step 256 to determine whether there is at least one occupant in the interior region 148. If there is at least one occupant in the interior region 148, step 258 directs the method to run Process 400 (shown in FIGS. 14A-14C) for each occupant in workspace region 150. In step 260, if an occupant's status is null (i.e., that occupant has left the workspace), that occupant is deleted from the list of occupants. In step 262, if there is more than one occupant in the workspace 150, the method is directed to run Process 500 (shown in FIGS. 15A-C) and Process 600 (shown in FIG. 16) before proceeding to step 264.

According to step 256, if there is not a least one occupant in the interior region 148, the process is directed in step 264 to run process 300 (shown in FIGS. 13A-B) before copying the current image to the previous image in step 256 and returning to step 202 from step 268.

FIGS. 13A-B illustrate example Process 300, which defines one or more new occupants if a blob of motions has been detected in the controlled space 110. Process 300 starts with step 302 which determines whether there is a region of one or more contiguous pixel groupings corresponding to non-persistent motion (blobs) not defined by a bounding box. If there is not, the method may return to Process 200, step 202. If one or more blobs are detected, example step 304 uses Matlab to find all connected components in the motion image to perform blob detection, but ignores any regions already covered by a bounding box. In step 306, a rectangle is created for each blob found in step 304. In step 308, if the overlapping area of the blob's rectangle and the inner border region 144 is greater than some predetermined percentage of the blob's rectangle, the blob is considered to be an occupant and a bounding box that contains the blob and is within inner border region 144 is created in step 310. If however, the overlapping area is less than the predetermined percentage of the blob's rectangle, the blob is added to an array of potential new occupants and process proceeds to step 318.

Continuing from step 310, example step 312 adds the bounding box to the list or array of rectangles that define the occupant's motions. In example step 314, if at least one bounding box was created, the process continues to step 316 (shown in FIG. 13B). If no new bounding box was created, the method is directed to return to Process 200, step 202.

In example step 316, the process creates on rectangle that contains all the rectangles in the array referred to in step 312. Example step 318 calculates the distance from the centroid of the blob to the centroid of the rectangle, created in step 316, and determines whether the centroid of the rectangle is less than some predetermined threshold. The distance from the centroid of the blob to the centroid of the rectangle may be calculated using the k-means algorithm described above. If the distance from the centroid of the blob to the centroid of the rectangle created in step 316 is less than the predetermined threshold, the rectangle is expanded such that it includes the outlying blob but is still within the image. In example step 320, the process indicates a positive detection of a new occupant in the room.

FIGS. 14A-C illustrate example steps of the method 400 for tracking an occupant within the controlled space 110. In step 402, a region of interest (ROI) is defined that is larger than an occupant's bounding box by some predetermined margin and has the same center as the bounding box. In step 404, if the occupant's status is locked and either the width or height of the ROI is less than a predetermined body size, the respective dimension of the ROI is resized to be the same as the predetermined body size. In step 406, any regions of the ROI that are outside the workspace region 150 (from FIG. 10) are cropped. In step 408, Matlab's bwconncomp( ) and regionprops( ) functions may be used to find all connected components (or pixels) in the motion image for blob detection. In step 410, for each blob detected in step 408, if the blob overlaps the ROI by at least one pixel, a rectangle that bounds the blob and is fully inside the image is created and added to an array of rectangles that bound individual blobs. In step 412, if a rectangle was added in step 410, the process proceeds to step 420, else the process proceeds to step 450.

In FIG. 14B, process 400 continues with example step 420 wherein one rectangle that bounds all the rectangles created in step 410 is created. In step 422, if the rectangle that was created in step 420 is too small, i.e., smaller than the minimum size of an occupant, or has its center located further than some predetermined distance (relative to its position in the last image), the rectangle is considered invalid.

In example step 424, if the rectangle is valid, the method is directed to perform the Check Status Process 800. In example step 428, if the rectangle is invalid and the occupant's box status is locked, the rectangle is resized to the predetermined size of an occupant. In example step 300, the portions of the rectangle that are outside the image are cropped. In example steps 432 and 434, the method is directed to perform the Recapture Motion Process 700 and the Check Status Process 800, respectively.

FIG. 14C illustrates additional example steps in Process 400, continuing from step 412. In step 450, if the occupant's box status is locked, the process continues with example step 454 where the ROI is resized to be the predetermined size of a body and centered over the person. In step 456, the portions of the rectangle that are outside the image are cropped. Returning to example step 450, if the occupant's status is not locked, the occupant's status is set to ‘null-unlocked’ in step 452. Continuing with step 458 and 460, the method is directed to perform the Recapture Motion Process 700 and the Check Status Process 800.

FIGS. 15A-C illustrate example steps of the Check Split Process 500. Starting with step 502, the number of splits that need to occur are initialized to one. In example step 504, a histogram equalization is applied to the current frame and in step 506 a histogram equalization is applied to the reference frame. In example step 508, a difference image is created by taking the absolute value of the difference between the current frame and the reference frame. In example step 510, a new binary difference image is created where each pixel in the difference image which is above a predetermined threshold produces a one in the binary image and all other pixels in the binary image are zero.

Proceeding to example step 512, the new binary difference image is eroded and dilated using a predetermined pattern. In example step 514, a motion history image is created by performing a logical OR operation on the motion image and binary image generated in step 224 of Process 200, described above. In example step 516, Matlab may be used to find all connected components in the motion image for blob detection. In example steps 518 and 520, for every possible pair of two occupants in the array of occupants, the bounding boxes of the occupants are compared to determine if they are identical. If the bounding boxes are identical, process proceeds to step 532. If the bounding boxes are not identical, the process proceeds to step 552.

FIG. 15B illustrates example steps 532-536. In step 532, a split flag is set to ‘true’, in step 534, the number of splits that need to occur is incremented by one. In step 536, for each blob found in step 514, above, if the blob's centroid is within the bounding box of the two occupants, the blob is added to an array of blobs that need to be split.

FIG. 15C illustrates continued example steps from step 520, above. In step 552, a rectangle that represents the overlapping area of the two occupants' rectangles is created. In step 554, the areas of the two occupants' bounding boxes are calculated. In step 556, if the two bounding boxes have any area of overlap, the area of the rectangle that represents the overlapping area of the two occupants' rectangles is calculated. In step 558, the area of the bounding boxes of the two occupants are compared to a predetermined body area. In step 560, if either of the bounding boxes are greater than a predetermined body area by some predetermined threshold, their split flag is set to ‘true’. In step 562, the number of splits that need to occur is incremented by one. In step 564, if the blob's centroid is within the bounding box of either of the two occupants, that blob is added to an array of blobs that need to be split.

FIG. 16 illustrates example steps in the Split Module Process 600. In step 602, the k-means algorithm may be applied to the set of centroids of the blobs from the Check Split Process 500 to create n-groups of blobs, where n is the number of splits that need to occur as provided by the Check Split Process 500. In step 604, for each blob in the list that need to be split, the blob's bounding box is added to an array of boxes that belong to whichever occupant the k-means algorithm indicates. In step 606, a box is created that contains all the boxes from step 604 that are within the room for each occupant indicated by the k-means algorithm. Example step 608 proceeds by directing the process to run the Check Status Process 800.

FIGS. 17A-B illustrate example steps of the Recapture Motion Process 700. Example steps 702-712 are similar to Example steps 504-516 in Process 500. In example step 702, a histogram equalization is applied to the current grayscale image and to the reference grayscale image. In example step 704, a difference image is created by taking the absolute value of the difference between the current image and the reference image. In example step 706, a new binary difference image is created where each pixel in the difference image which is above a predetermined threshold produces a one in the binary image and all other pixels in the binary image are zero.

Proceeding to example step 708, the new binary difference image is eroded and dilated using a predetermined pattern. In example step 710, a motion history image is created by performing a logical OR operation on the motion image and binary image generated in step 224 of Process 200, described above. In example step 712, Matlab may be used for blob detection.

In step 714, if the percentage of overlap between the blob and the ROI is greater than some predetermine threshold, the process proceeds to step 718. If not, the process continues with step 716 where the blob's position and size information are added to an array of the blob's information.

Continuing with FIG. 17B, in example step 718, a rectangle may be created that bounds the blob and is fully inside the image. In step 720, the rectangle may be added to an array of rectangles that bound individual blobs. In step 722, if two or more rectangles were created in step 720, one rectangle may be created that bounds all the blobs. In example step 724, if there are multiple elements in the array created from step 716, for each blob outside the ROI, if the distance from the centroid of the blob to the centroid of the box created in 722 is less than some predetermined threshold, the box created in step 722 may be expanded such that it includes the outlying blob and is within the image.

FIG. 18 illustrates example steps in the Check Status Process 800. In step 802, if there is motion detected from an occupant, the number of pixels of the occupant's bounding box that overlap the inner border region 144, the outer border region 140, the task region 152, and the workspace region 150, are calculated.

In step 804, if most of the overlapping pixels are in the outer border region, the occupant status is set to ‘outer-border region, unlocked’. In step 806, if most of the overlapping pixels are in the inner border region, the occupant's status is set to ‘inner-border region, locked’. In step 810, if most of the overlapping pixels are in the task region, the occupant's status is set to ‘task-locked’. In step 812, if most of the overlapping pixels are in the task region, the occupant's status is set to ‘workspace region-locked’.

### VII. Hardware

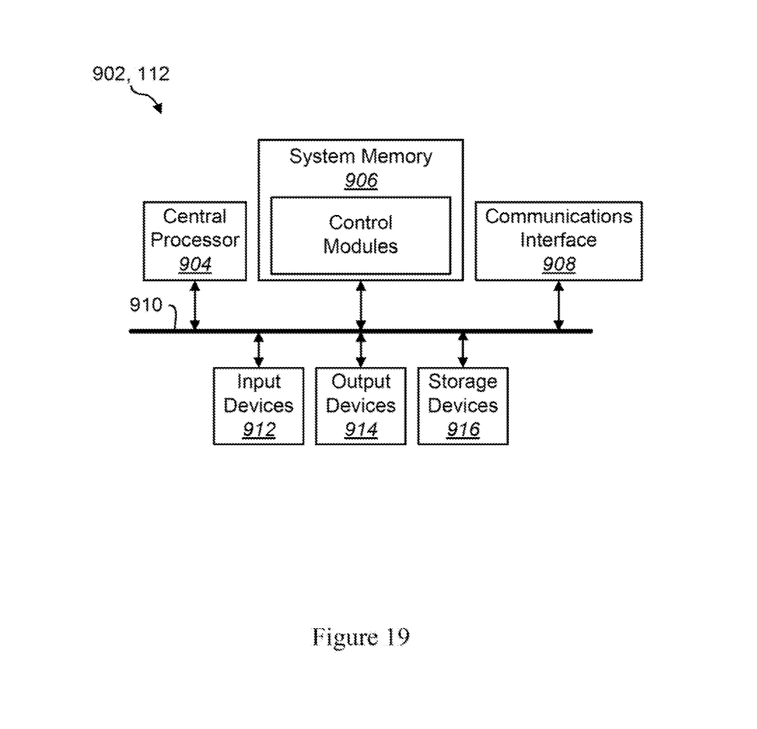

FIG. 19 depicts a block diagram of an electronic device 902 suitable for implementing the present systems and methods. The electronic device 902 includes a bus 910 which interconnects major subsystems of electronic device 902, such as a central processor 904, a system memory 906 (typically RAM, but which may also include ROM, flash RAM, or the like), a communications interface 908, input devices 912, output device 914, and storage devices 916 (hard disk, floppy disk, optical disk, etc.).

Bus 910 allows data communication between central processor 904 and system memory 906, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the controller 112 to implement the present systems and methods may be stored within the system memory 906. The controller 112 may be an example of the controller of FIGS. 1-3. Applications or algorithms resident with the electronic device 902 are generally stored on and accessed via a non-transitory computer readable medium (stored in the system memory 906, for example), such as a hard disk drive, an optical drive, a floppy disk unit, or other storage medium. Additionally, applications can be in the form of electronic signals modulated in accordance with the application and data communication technology when accessed via the communications interface 908

Communications interface 908 may provide a direct connection to a remote server or to the Internet via an internet service provider (ISP). Communications interface 908 may provide a direct connection to a remote server via a direct network link to the Internet via a POP (point of presence). Communications interface 608 may provide such connection using wireless techniques, including digital cellular telephone connection, Cellular Digital Packet Data (CDPD) connection, digital satellite data connection, or the like.

Many other devices or subsystems (not shown) may be connected in a similar manner. Conversely, all of the devices shown in FIG. 19 need not be present to practice the present systems and methods. The devices and subsystems can be interconnected in different ways from that shown in FIG. 19. The operation of an electronic device such as that shown in FIG. 19 is readily known in the art and is not discussed in detail in this application. Code to implement the present disclosure can be stored in a non-transitory computer-readable medium such as one or more of system memory 906 and the storage devices 916.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational or final functional aspect of the first signal.

While the foregoing disclosure sets forth various embodiments using specific block diagrams, flowcharts, and examples, each block diagram component, flowchart step, operation, or component described or illustrated herein may be implemented, individually or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described or illustrated herein are given by way of example only and can be varied as desired. For example, while the steps illustrated or described herein may be shown or discussed in a particular order, these steps do not necessarily need to be performed in the order illustrated or discussed. The various exemplary methods described or illustrated herein may also omit one or more of the steps described or illustrated herein or include additional steps in addition to those disclosed.

Furthermore, while various embodiments have been described or illustrated herein in the context of fully functional electronic devices, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in an electronic device. In some embodiments, these software modules may configure an electronic device to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.”

What is claimed is:

1. A computer-implemented method for monitoring and controlling a controlled space, the method comprising:
partitioning a controlled space into one or more regions;
evaluating motion within the controlled space; and
determining occupancy within the one or more regions.

2. The method of claim 1, wherein determining occupancy comprises:
defining one or more new occupants;
tracking the one or more occupants; and
checking the status of the one or more occupants.

3. The method of claim 2, wherein checking the status of the one or more occupants comprises driving a state machine with a plurality of triggers corresponding to a location of the one or more occupants within a region of the controlled space.

4. The method of claim 3, wherein a trigger of the plurality of triggers is selected from the group consisting of a motion disappear trigger, a workspace-locked trigger, a task-locked trigger, an outer border region-unlocked trigger, an inner border region-locked trigger, and a failsafe timeout trigger.

5. The method of claim 3, further comprising adjusting conditions within the controlled space based one or more triggers of the plurality of triggers being present in the state machine.

6. The method of claim 5, wherein adjusting conditions is selected from the group consisting of adjusting general lighting, adjusting task lighting, adjusting heating, adjusting ventilation, and adjusting cooling.

7. The method of claim 3, wherein the state machine comprises one or more occupied states and one or more transition states.

8. The method of claim 7, wherein the transition states comprises a first transition state corresponding to the outer border trigger and a second transition state corresponding to the inner border trigger.

9. The method of claim 2, wherein defining the one or more new occupants comprises:
identifying one or more contiguous pixel groupings corresponding to non-persistent motion in a motion image of the controlled space;
creating a bounding box surrounding the region of one or more contiguous pixel groupings corresponding to non-persistent motion; and
adding the bounding box to an array of rectangles the define an occupant's motion.

10. The method of claim 2, wherein tracking the one or more occupants comprises:
defining a region of interest within the controlled space that has the same center and is larger than a bounding box of an occupant;
identifying one or more contiguous pixel groupings corresponding to non-persistent motion in a motion image of the controlled space;
creating one or more rectangles that bound individual contiguous pixel grouping from the one or more contiguous pixel groupings;
creating a single rectangle that bounds the one or more rectangles; and
checking the status of the single rectangle.

11. A system for monitoring and controlling a controlled space, comprising:
a sensor interface module configured to collect a sequence of images of a controlled space;
a partitioning module configured to partition out of the controlled space an inner border region, an outer border region, and one or more interior regions;
a motion evaluation module configured to evaluate from the sequence of images of the controlled space whether non-persistent motion has occurred within the inner border region, the outer border region and the one or more interior regions; and
an occupant detection module configured define, track, and check the status of one or more occupants in the controlled space.

12. The system of claim 11, further comprising a state machine module with one or more triggers corresponding to a location of an occupant within specific regions of the controlled space.

13. The system of claim 12, wherein a trigger of the plurality of triggers is selected from the group consisting of a motion disappear trigger, a workspace-locked trigger, a task-locked trigger, an outer border region-unlocked trigger, an inner border region-locked trigger, and a failsafe timeout trigger.

14. The system of claim 12, wherein the state machine comprises one or more occupied states and one or more transition states.

15. The system of claim 14, wherein the transition states comprises a first transition state corresponding to the outer border trigger and a second transition state corresponding to the inner border trigger.

16. The system of claim 11, further comprising a conditions control module for adjusting conditions within the controlled space based on the one or more triggers.

17. The system of claim 16, wherein the conditions control module is configured to make an adjustment selected from the group consisting of a general lighting adjustment, a task lighting adjustment, a heating adjustment, a ventilation adjustment, and a cooling adjustment.

18. The system of claim 11, wherein the occupant detection module comprises a define new occupant module configured to:
identify one or more contiguous pixel groupings corresponding to non-persistent motion in a motion image of the controlled space;
create a bounding box surrounding the region of one or more contiguous pixel groupings corresponding to non-persistent motion; and
add the bounding box to an array of rectangles the define an occupant's motion.

19. The system of claim 18, wherein the occupant detection module comprises a track occupant module configured to:
define a region of interest within the controlled space that has the same center and is larger than a bounding box of an occupant;
identify one or more contiguous pixel groupings corresponding to non-persistent motion in a motion image of the controlled space;
create one or more rectangles that bound individual contiguous pixel grouping from the one or more contiguous pixel groupings;
create a single rectangle that bounds the one or more rectangles; and
check the status of the single rectangle.

20. A system for monitoring and controlling a controlled space, the system comprising:
a sensor configured to provide a sequence of images for a controlled space;
a controller configured to:
receive the sequence of images for the controlled space;
partition out of the controlled space an inner border region, an outer border region, and one or more interior regions;
identify, count, and track a position of one or more occupants within the controlled space or regions thereof;
use the position of the one or more occupants to drive one or more triggers of a state machine; and
a controllable device selected from the group consisting of a lighting device, a heating device, a cooling device, and a ventilation device.
